(19) United States
(12) Patent Application Publication
(10) Pub. No.: US 2023/0232426 A1
(43) Pub. Date: Jul. 20, 2023

(54) SIDELINK SYNCHRONIZATION SIGNAL BLOCK (S-SSB) TRANSMISSIONS IN A SHARED SPECTRUM

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Yisheng XUE, San Diego, CA (US); Changlong XU, Beijing (CN); Tao LUO, San Diego, CA (US); Sony AKKARAKARAN, Poway, CA (US); Juan MONTOJO, San Diego, CA (US); Ozcan OZTURK, San Diego, CA (US)

(21) Appl. No.: 18/001,696

(22) PCT Filed: Jul. 14, 2020
(86) PCT No.: PCT/CN2020/101895

§ 371 Date: Dec. 13, 2022

(51) Int. Cl. H04W 72/25; H04W 72/044; H04L 1/00; H04W 56/00

(52) U.S. Cl. CPC H04W 72/25; H04W 72/046; H04L 1/0013; H04W 56/001

(57) ABSTRACT

Methods, systems, and devices for wireless communications are described. A UE may identify a configuration of sidelink synchronization signal block instances including a first quantity of sidelink synchronization signal block instances for each of a plurality of sidelink synchronization signal block periods. The UE may transmit a second quantity of sidelink synchronization signal block instances over a first sidelink synchronization signal block period. In some aspects, the UE may transmit a sidelink synchronization signal block burst using beams in a sidelink synchronization signal block period. The UE may identify a configuration for a set of resources of a sidelink beam selection resource pool based on transmitting the sidelink synchronization signal block burst. The UE may receive, from another UE over the set of resources, a control message including an indication of preferred beams. The UE may transmit the sidelink data to the other UE using the preferred beams.

### CROSS REFERENCE

The present application is a 371 national stage filing of International PCT Application No. PCT/CN2020/101895 by Liu et al. entitled “SIDELINK SYNCHRONIZATION SIGNAL BLOCK (S-SSB) TRANSMISSIONS IN A SHARED SPECTRUM,” filed Jul. 14, 2020, which is assigned to the assignee hereof, and which is expressly incorporated by reference in its entirety herein.

### FIELD OF TECHNOLOGY

The following relates generally to wireless communications and more specifically to sidelink synchronization signal block (S-SSB) transmissions in a shared spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include a number of base stations or network access nodes, each simultaneously supporting communication for multiple communication devices, which may be otherwise known as user equipment (UEs). Some wireless communications systems may support sidelink communications between UEs (e.g., direct communications between UEs). Improved techniques for supporting synchronization of communications between UEs may be desirable.

### SUMMARY

The present disclosure relates to methods, systems, devices, and apparatuses that support sidelink synchronization signal block (S-SSB) transmissions in a shared spectrum. Generally, the described techniques provide for dynamic configuration of S-SSB block instances for an S-SSB period or efficient configuration of a sidelink beam selection resource pool based on transmitting a S-SSB burst. In one aspect, a UE may identify a configuration of S-SSB instances including a first quantity of S-SSB instances (e.g., an initial quantity based on a configuration) for a S-SSB period. In an aspect, the UE may determine a second quantity of S-SSB instances (e.g., by determining a subsampling of S-SSBs associated with the first quantity of S-SSB instances) and transmit the second quantity of S-SSB instances over a second S-SSB period. The UE may determine the second quantity of S-SSB instances based on an orientational movement of the UE over the S-SSB period.

In another aspect, a UE (e.g., an anchor UE) may configure a sidelink beam selection resource pool based on transmitting a S-SSB burst. Another UE (e.g., a client UE) may select a set of preferred beams based on S-SSBs transmitted in the S-SSB burst and communicate the selection to the UE over a physical sidelink shared channel (PSSCH) transmission. The other UE may indicate the beam selection via a sidelink control information (SCI) format (e.g., an SCI-2 format which may be in PSSCH scheduled by SCI-1 in the physical sidelink control channel (PSCCH)). The UE may transmit sidelink data to the other UE using the preferred beams.

A method of wireless communication at a UE is described. The method may include identifying a configuration including a first quantity of sidelink synchronization signal block instances for each of a set of sidelink synchronization signal block periods, determining a second quantity of sidelink synchronization signal block instances for a first sidelink synchronization signal block period of the set of sidelink synchronization signal block periods, where the second quantity is different from the first quantity, and transmitting the second quantity of sidelink synchronization signal block instances over the first sidelink synchronization signal block period.

An apparatus for wireless communication at a UE is described. The apparatus may include a processor, memory coupled with the processor, and instructions stored in the memory. The instructions may be executable by the processor to cause the apparatus to identify a configuration including a first quantity of sidelink synchronization signal block instances for each of a set of sidelink synchronization signal block periods, determine a second quantity of sidelink synchronization signal block instances for a first sidelink synchronization signal block period of the set of sidelink synchronization signal block periods, where the second quantity is different from the first quantity, and transmit the second quantity of sidelink synchronization signal block instances over the first sidelink synchronization signal block period.

Another apparatus for wireless communication at a UE is described. The apparatus may include means for identifying a configuration including a first quantity of sidelink synchronization signal block instances for each of a set of sidelink synchronization signal block periods, determining a second quantity of sidelink synchronization signal block instances for a first sidelink synchronization signal block period of the set of sidelink synchronization signal block periods, where the second quantity is different from the first quantity, and transmitting the second quantity of sidelink synchronization signal block instances over the first sidelink synchronization signal block period.

A non-transitory computer-readable medium storing code for wireless communication at a UE is described. The code may include instructions executable by a processor to identify a configuration including a first quantity of sidelink synchronization signal block instances for each of a set of sidelink synchronization signal block periods, determine a second quantity of sidelink synchronization signal block instances for a first sidelink synchronization signal block period of the set of sidelink synchronization signal block periods, where the second quantity is different from the first quantity, and transmit the second quantity of sidelink synchronization signal block instances over the first sidelink synchronization signal block period.

In some examples of the method, apparatuses, and non-transitory computer-readable medium described herein, determining the second quantity of sidelink synchronization signal block instances may include operations, features, means, or instructions for determining a subsampling of sidelink synchronization signal blocks associated with the first quantity of sidelink synchronization signal block instances.

Some examples of the method, apparatuses, and non-transitory computer-readable medium described herein may further include operations, features, means, or instructions for determining an orientational movement of the UE over one or more sidelink synchronization signal block periods based on an orientation sensor of the UE, and determining the second quantity of sidelink synchronization signal block instances based on determining the orientational movement.

Some examples of the method, apparatuses, and non-transitory computer-readable medium described herein may further include operations, features, means, or instructions for determining that an orientational movement of the UE over a second sidelink synchronization signal block period satisfies an orientational movement threshold, and transmitting the first quantity of sidelink synchronization signal block instances over a third sidelink synchronization signal block period based on determining that the orientational movement of the UE over the second sidelink synchronization signal block period satisfies the orientational movement threshold.

Some examples of the method, apparatuses, and non-transitory computer-readable medium described herein may further include operations, features, means, or instructions for receiving a message from a base station, where identifying the configuration for the first quantity of sidelink synchronization signal block instances may be based on receiving the message.

A method of wireless communication at a UE is described. The method may include transmitting a sidelink synchronization signal block burst using one or more beams in a sidelink synchronization signal block period, identifying a configuration for a set of resources of a sidelink beam selection resource pool based on transmitting the sidelink synchronization signal block burst, receiving, from another UE over a resource of the set of resources, a control message including an indication of one or more preferred beams of the one or more beams for transmitting sidelink data to the other UE, and transmitting the sidelink data to the other UE using the one or more preferred beams.

An apparatus for wireless communication at a UE is described. The apparatus may include a processor, memory coupled with the processor, and instructions stored in the memory. The instructions may be executable by the processor to cause the apparatus to transmit a sidelink synchronization signal block burst using one or more beams in a sidelink synchronization signal block period, identify a configuration for a set of resources of a sidelink beam selection resource pool based on transmitting the sidelink synchronization signal block burst, receive, from another UE over a resource of the set of resources, a control message including an indication of one or more preferred beams of the one or more beams for transmitting sidelink data to the other UE, and transmit the sidelink data to the other UE using the one or more preferred beams.

Another apparatus for wireless communication at a UE is described. The apparatus may include means for transmitting a sidelink synchronization signal block burst using one or more beams in a sidelink synchronization signal block period, identifying a configuration for a set of resources of a sidelink beam selection resource pool based on transmitting the sidelink synchronization signal block burst, receiving, from another UE over a resource of the set of resources, a control message including an indication of one or more preferred beams of the one or more beams for transmitting sidelink data to the other UE, and transmitting the sidelink data to the other UE using the one or more preferred beams.

A non-transitory computer-readable medium storing code for wireless communication at a UE is described. The code may include instructions executable by a processor to transmit a sidelink synchronization signal block burst using one or more beams in a sidelink synchronization signal block period, identify a configuration for a set of resources of a sidelink beam selection resource pool based on transmitting the sidelink synchronization signal block burst, receive, from another UE over a resource of the set of resources, a control message including an indication of one or more preferred beams of the one or more beams for transmitting sidelink data to the other UE, and transmit the sidelink data to the other UE using the one or more preferred beams.

In some examples of the method, apparatuses, and non-transitory computer-readable medium described herein, receiving the control message may include operations, features, means, or instructions for receiving a first control message in a physical sidelink control channel transmission, and receiving a second control message in a physical sidelink shared channel transmission, where the second control message includes the indication.

Some examples of the method, apparatuses, and non-transitory computer-readable medium described herein may further include operations, features, means, or instructions for identifying, based on a field of the first control message, that the physical sidelink shared channel transmission may be within a first subset of resources of a slot of the physical sidelink shared channel.

Some examples of the method, apparatuses, and non-transitory computer-readable medium described herein may further include operations, features, means, or instructions for identifying that a second subset of resources of the slot of the physical sidelink shared channel includes rate matching information associated with the second control message, and receiving the second control message based on the rate matching information.

Some examples of the method, apparatuses, and non-transitory computer-readable medium described herein may further include operations, features, means, or instructions for identifying that a second subset of resources of the slot of the physical sidelink shared channel may be exclusive of the physical sidelink shared channel transmission, and transmitting an acknowledgement associated with the one or more preferred beams, using at least a portion of the second subset of resources of the slot.

Some examples of the method, apparatuses, and non-transitory computer-readable medium described herein may further include operations, features, means, or instructions for identifying, based on the second control message, a last symbol of the first subset of resources of the slot, and identifying rate matching information associated with the second control message in at least one resource associated with the last symbol.

In some examples of the method, apparatuses, and non-transitory computer-readable medium described herein, the second control message may include operations, features, means, or instructions for a beam index associated with the one or more preferred beams, a reference signal received power value associated with the one or more preferred beams, a source identifier associated with the UE, a destination identifier associated with the other UE, a trigger associated with transmitting an acknowledgement indicator corresponding to the one or more preferred beams, a new data indicator, a hybrid automatic repeat request identifier; or, and a combination thereof.

Some examples of the method, apparatuses, and non-transitory computer-readable medium described herein may further include operations, features, means, or instructions for transmitting an acknowledgement indicator to the other UE on a physical sidelink feedback channel resource using the one or more preferred beams.

Some examples of the method, apparatuses, and non-transitory computer-readable medium described herein may further include operations, features, means, or instructions for selecting a beam from the one or more preferred beams, transmitting an acknowledgement indicator to the other UE on a physical sidelink feedback channel resource associated with the selected beam, and where transmitting the sidelink data to the other UE using the one or more preferred beams includes transmitting the sidelink data to the other UE using the selected beam.

Some examples of the method, apparatuses, and non-transitory computer-readable medium described herein may further include operations, features, means, or instructions for identifying the priority associated with the second control message based on the first control message, and receiving the second control message based on identifying the priority.

In some examples of the method, apparatuses, and non-transitory computer-readable medium described herein, the sidelink beam selection resource pool includes resources of a physical feedback sidelink channel.

In some examples of the method, apparatuses, and non-transitory computer-readable medium described herein, the physical feedback sidelink channel includes a set of sets of resources determined based on a number of beams associated with the sidelink synchronization signal block burst.

Some examples of the method, apparatuses, and non-transitory computer-readable medium described herein may further include operations, features, means, or instructions for receiving a positive acknowledgement indicator from the other UE over a set of physical sidelink feedback channel resources included in the set of resources for the sidelink beam selection resource pool, determine the one or more preferred beams based on an association between the set of physical sidelink feedback channel resources and the one or more beams, and determining a UE identifier associated with the other UE based on a resource included in the set of physical sidelink feedback channel resources.

In some examples of the method, apparatuses, and non-transitory computer-readable medium described herein, receiving the control message may include operations, features, means, or instructions for receiving a medium access control (MAC) control element (MAC-CE) including the indication of the one or more preferred beams.

A method of wireless communication at a UE is described. The method may include identifying a sidelink synchronization signal block burst transmitted using one or more beams in a sidelink synchronization signal block period, receiving, from another UE, one or more sidelink synchronization signal blocks using the one or more beams, selecting one or more preferred beams of the one or more beams based on receiving the one or more sidelink synchronization signal blocks, transmitting a control message including an indication of the one or more preferred beams to the other UE, over a resource of a set of resources of a sidelink beam selection resource pool, where the set of resources of the sidelink beam selection resource pool is associated with the sidelink synchronization signal block burst, and receiving sidelink data from the other UE using the one or more preferred beams.

An apparatus for wireless communication at a UE is described. The apparatus may include a processor, memory coupled with the processor, and instructions stored in the memory. The instructions may be executable by the processor to cause the apparatus to identify a sidelink synchronization signal block burst transmitted using one or more beams in a sidelink synchronization signal block period, receive, from another UE, one or more sidelink synchronization signal blocks using the one or more beams, select one or more preferred beams of the one or more beams based on receiving the one or more sidelink synchronization signal blocks, transmit a control message including an indication of the one or more preferred beams to the other UE, over a resource of a set of resources of a sidelink beam selection resource pool, where the set of resources of the sidelink beam selection resource pool is associated with the sidelink synchronization signal block burst, and receive sidelink data from the other UE using the one or more preferred beams.

Another apparatus for wireless communication at a UE is described. The apparatus may include means for identifying a sidelink synchronization signal block burst transmitted using one or more beams in a sidelink synchronization signal block period, receiving, from another UE, one or more sidelink synchronization signal blocks using the one or more beams, selecting one or more preferred beams of the one or more beams based on receiving the one or more sidelink synchronization signal blocks, transmitting a control message including an indication of the one or more preferred beams to the other UE, over a resource of a set of resources of a sidelink beam selection resource pool, where the set of resources of the sidelink beam selection resource pool is associated with the sidelink synchronization signal block burst, and receiving sidelink data from the other UE using the one or more preferred beams.

A non-transitory computer-readable medium storing code for wireless communication at a UE is described. The code may include instructions executable by a processor to identify a sidelink synchronization signal block burst transmitted using one or more beams in a sidelink synchronization signal block period, receive, from another UE, one or more sidelink synchronization signal blocks using the one or more beams, select one or more preferred beams of the one or more beams based on receiving the one or more sidelink synchronization signal blocks, transmit a control message including an indication of the one or more preferred beams to the other UE, over a resource of a set of resources of a sidelink beam selection resource pool, where the set of resources of the sidelink beam selection resource pool is associated with the sidelink synchronization signal block burst, and receive sidelink data from the other UE using the one or more preferred beams.

In some examples of the method, apparatuses, and non-transitory computer-readable medium described herein, transmitting the control message may include operations, features, means, or instructions for transmitting a first control message in a physical sidelink control channel transmission, and transmitting a second control message in a physical sidelink shared channel transmission, where the second control message includes the indication.

Some examples of the method, apparatuses, and non-transitory computer-readable medium described herein may further include operations, features, means, or instructions for identifying that the second control message includes fewer information bits than a quantity of bits available in resources of a slot of a physical sidelink shared channel, and indicating, in a field of the first control message, that the physical sidelink shared channel transmission may be within a first subset of resources of the slot of the physical sidelink shared channel.

Some examples of the method, apparatuses, and non-transitory computer-readable medium described herein may further include operations, features, means, or instructions for transmitting rate matching information associated with the second control message over the second subset of resources of the slot of the physical sidelink shared channel.

Some examples of the method, apparatuses, and non-transitory computer-readable medium described herein may further include operations, features, means, or instructions for suppressing transmission of the physical sidelink shared channel transmission for a second subset of resources of the slot of the physical sidelink shared channel.

Some examples of the method, apparatuses, and non-transitory computer-readable medium described herein may further include operations, features, means, or instructions for receiving an acknowledgement associated with the one or more preferred beams, using at least a portion of the second subset of resources of the slot.

Some examples of the method, apparatuses, and non-transitory computer-readable medium described herein may further include operations, features, means, or instructions for identifying, from a set of symbols associated with the physical sidelink shared channel, a first symbol carrying a demodulation reference signal, and mapping the second control message to the first subset of resources of the physical sidelink shared channel based on identifying the first symbol.

Some examples of the method, apparatuses, and non-transitory computer-readable medium described herein may further include operations, features, means, or instructions for identifying a last symbol of the first subset of resources of the slot, and transmitting rate matching information associated with the second control message in at least one resource associated with the last symbol.

In some examples of the method, apparatuses, and non-transitory computer-readable medium described herein, the second control message may include operations, features, means, or instructions for a beam index associated with the one or more preferred beams, a reference signal received power value associated with the one or more preferred beams, a source identifier associated with the other UE, a destination identifier associated with the UE, a trigger associated with transmitting an acknowledgement indicator corresponding to the one or more preferred beams, a new data indicator, a hybrid automatic repeat request identifier, and or a combination thereof.

Some examples of the method, apparatuses, and non-transitory computer-readable medium described herein may further include operations, features, means, or instructions for receiving an acknowledgement indicator from the other UE on a physical sidelink feedback channel resource using the one or more preferred beams.

Some examples of the method, apparatuses, and non-transitory computer-readable medium described herein may further include operations, features, means, or instructions for receiving an acknowledgement indicator from the other UE on a physical sidelink feedback channel resource associated with a beam selected from the one or more preferred beams by the other UE, and where receiving the sidelink data from the other UE using the one or more preferred beams includes receiving the sidelink data from the other UE using the selected beam.

Some examples of the method, apparatuses, and non-transitory computer-readable medium described herein may further include operations, features, means, or instructions for setting the priority associated with the second control message, indicating, in the first control message, the priority associated with the second control message, and transmitting the second control message based on setting the priority, transmitting the first control message indicating the priority, or both.

In some examples of the method, apparatuses, and non-transitory computer-readable medium described herein, the sidelink beam selection resource pool includes resources or a physical feedback sidelink channel.

Some examples of the method, apparatuses, and non-transitory computer-readable medium described herein may further include operations, features, means, or instructions for determining a set of sets of resources based on a number of beams associated with the sidelink synchronization signal block burst, where the physical sidelink feedback channel includes the set of sets of resources.

Some examples of the method, apparatuses, and non-transitory computer-readable medium described herein may further include operations, features, means, or instructions for selecting one or more sets of resources from the set of sets of resources based on the one or more preferred beams, selecting one or more resources of the one or more sets of resources based on, and transmitting the indication of the one or more preferred beams to the other UE over the selected one or more resources.

In some examples of the method, apparatuses, and non-transitory computer-readable medium described herein, transmitting the control message may include operations, features, means, or instructions for transmitting a MAC-CE, where the MAC-CE includes the indication.

### BRIEF DESCRIPTION OF THE DRAWINGS

FIG. 1 illustrates an example of a system for wireless communications that supports sidelink synchronization signal block (S-SSB) transmissions in a shared spectrum in accordance with aspects of the present disclosure.

FIG. 2 illustrates an example of a wireless communications system that supports S-SSB transmissions in a shared spectrum in accordance with aspects of the present disclosure.

FIG. 3 illustrates an example of S-SSB transmissions that support S-SSB transmissions in a shared spectrum in accordance with aspects of the present disclosure.

FIG. 4 illustrates an example of S-SSB transmissions that support S-SSB transmissions in a shared spectrum in accordance with aspects of the present disclosure.

FIG. 5 illustrates an example of S-SSB transmissions that support S-SSB transmissions in a shared spectrum in accordance with aspects of the present disclosure.

FIG. 6 illustrates an example of a S-SSB transmissions that support S-SSB transmissions in a shared spectrum in accordance with aspects of the present disclosure.

FIG. 7 illustrates an example of S-SSB transmissions that support S-SSB transmissions in a shared spectrum in accordance with aspects of the present disclosure.

FIG. 8 illustrates an example of transmissions that support S-SSB transmissions in a shared spectrum in accordance with aspects of the present disclosure.

FIGS. 9A and 9B illustrate examples of transmissions that support S-SSB transmissions in a shared spectrum in accordance with aspects of the present disclosure.

FIG. 10 illustrates an example of a process flow that supports S-SSB transmissions in a shared spectrum in accordance with aspects of the present disclosure.

FIGS. 11 and 12 show block diagrams of devices that support S-SSB transmissions in a shared spectrum in accordance with aspects of the present disclosure.

FIG. 13 shows a block diagram of a communications manager that supports S-SSB transmissions in a shared spectrum in accordance with aspects of the present disclosure.

FIG. 14 shows a diagram of a system including a device that supports S-SSB transmissions in a shared spectrum in accordance with aspects of the present disclosure.

FIGS. 15 through 20 show flowcharts illustrating methods that support S-SSB transmissions in a shared spectrum in accordance with aspects of the present disclosure.

### DETAILED DESCRIPTION

Some wireless communications systems may support sidelink communications between user equipment (UEs) in a shared spectrum. For instance, such systems may support sidelink synchronization signal block (S-SSB) transmissions between multiple UEs in the shared spectrum. In some cases, a UE may support beam sweeping multiple S-SSBs in the shared spectrum, where S-SSB slots may be mapped to different beams. In such systems, orientational movement of an anchor UE (e.g., S-SSB transmitter) may be detrimental to S-SSB beam sweeping and beam selection. In an aspect, the anchor UE may rotate during an S-SSB beam sweeping period. Increased beam sweeping (e.g., more S-SSB bursts) may improve beam selection for high orientational movement, but introduce greater overhead for low orientational movement.

Such wireless communications systems may additionally support communicating beam selection information via a beam selection resource pool for sidelink communications between an anchor UE and a client UE. For example, the client UE may communicate to the anchor UE an indication of preferred beams for transmitting sidelink data between the anchor UE and the client UE. Some techniques may utilize a random access channel (RACH) preamble to communicate beam selection, which may be inefficient based on the compatibility with sidelink waveform formats and the number of operations associated with a RACH procedure.

As described herein, a UE may support efficient techniques for facilitating S-SSB transmissions in a shared spectrum. In particular, a UE may dynamically configure a set of S-SSB block instances. The UE may identify a configuration of the sidelink synchronization signal block instances based on a message from a base station. The configuration may include a first quantity of S-SSB instances (e.g., an initial quantity based on the configuration) for a S-SSB period. In an aspect, the UE may determine a second quantity of sidelink synchronization signal block instances and transmit the second quantity of S-SSB instances over a second S-SSB period. In some aspects, the UE may determine the second quantity of S-SSB instances by determining a subsampling of S-SSBs associated with the first quantity of S-SSB instances. In some aspects, the UE may determine the second quantity of S-SSB instances based on an orientational movement of the UE over a S-SSB period satisfying a threshold. Using these techniques, a UE may mitigate or reduce unnecessary overhead when beam sweeping multiple S-SSBs in the shared spectrum.

Techniques described herein may support improved sidelink communications between a UE (e.g., an anchor UE) and another UE (e.g., a client UE). The UE may configure a sidelink beam selection resource pool based on transmitting a S-SSB burst. The other UE may select a set of preferred beams based on S-SSBs transmitted in the S-SSB burst and communicate the selection to the UE. The beam selection may be indicated via a sidelink control information (SCI) format. In some cases, the beam selection may be transmitted over a physical sidelink shared channel (PSSCH)transmission (e.g., an SCI-2 format in PSSCH scheduled by SCI-1 in the physical sidelink control channel (PSCCH)). The other UE may indicate the beam indices for the preferred beams, reference signal received power (RSRP) measurements for the preferred beams, source identifier, destination identifier, whether a beam confirmation (e.g., an acknowledgement (ACK)) is triggered, or a new data indicator (NDI) and hybrid automatic repeat request identifier (HARQ ID) if used to schedule a data transmission.

The UE may acknowledge the preferred beams in a physical sidelink feedback channel (PSFCH). In some aspects, the other UE may send SCI-2 without additional data, in which case the other UE may include the SCI-2 in a subset of the PSSCH resources scheduled by the SCI-1. The other UE may rate match using the rest of the PSSCH resources, or in some aspects, rate match only the last symbol of the SCI-2 (e.g., not transmitting over the other PSSCH resources). In some aspects, the other UE may preserve the first demodulation reference signal (DMRS) symbol of the PSSCH, such that an ending symbol for transmission is at least after the first DMRS.

According to some aspects, the other UE may use resources of the PSFCH for transmission of beam selection information indicating the preferred beams. In an aspect, the PSFCH may be divided into sets of resources associated with each beam of the S-SSB burst, and the beam selection information may be determined based on used resources of the sets of resources. In some aspects, selection of a resource within a set of resources associated with a beam may indicate a client identifier of the client UE to the anchor UE. Using these techniques, a beam selection resource pool and beam selection information may be communicated with improved efficiency and reduced overhead.

Aspects of the disclosure introduced above are described below in the context of a wireless communications system. Examples of processes and signaling exchanges that support S-SSB transmissions in a shared spectrum are then described. Aspects of the disclosure are further illustrated by and described with reference to apparatus diagrams, system diagrams, and flowcharts that relate to S-SSB transmissions in a shared spectrum.

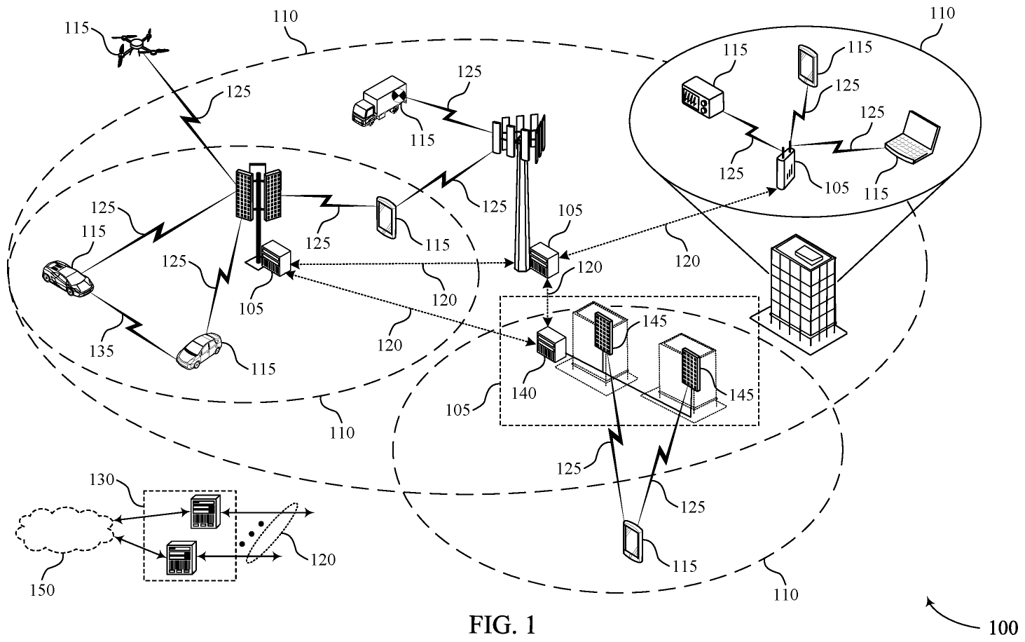

FIG. 1 illustrates an example of a wireless communications system 100 that supports S-SSB transmissions in a shared spectrum in accordance with aspects of the present disclosure. The wireless communications system 100 may include one or more base stations 105, one or more UEs 115, and a core network 130. In some aspects, the wireless communications system 100 may be a Long Term Evolution (LTE) network, an LTE-Advanced (LTE-A) network, an LTE-A Pro network, or a New Radio (NR) network. In some aspects, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For instance, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some aspects, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For instance, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some aspects (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink shared channel (PUSCH) or a physical uplink control channel (PUCCH)), or downlink transmissions from a base station 105 to a UE 115 (e.g., in a physical downlink shared channel (PDSCH) or a physical downlink control channel (PDCCH)). Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some aspects the carrier bandwidth may be referred to as a “system bandwidth” of the carrier or the wireless communications system 100. For instance, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some aspects, the wireless communications system 100 may include base stations 105 or UEs 115 that support simultaneous communications via carriers associated with multiple carrier bandwidths. In some aspects, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the base stations 105 or the UEs 115 may be expressed in multiples of a basic time unit which may, for instance, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some aspects, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for instance, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For instance, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a base station 105 may be movable and therefore provide communication coverage for a moving geographic coverage area 110. In some aspects, different geographic coverage areas 110 associated with different technologies may overlap, but the different geographic coverage areas 110 may be supported by the same base station 105. In other aspects, the overlapping geographic coverage areas 110 associated with different technologies may be supported by different base stations 105. The wireless communications system 100 may include, for instance, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For instance, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some aspects, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some aspects, groups of the UEs 115 communicating via D2D communications may utilize a one-to-many (1:M) system in which each UE 115 transmits to every other UE 115 in the group. In some aspects, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the base stations 105, and EHF antennas of the respective devices may be smaller and more closely spaced than UHF antennas. In some aspects, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

In some cases, wireless communications system 100 may utilize both unshared (e.g., licensed) and shared (e.g., unlicensed) radio frequency spectrum bands. According to some aspects, wireless communications system 100 may employ License Assisted Access (LAA), LTE-Unlicensed (LTE-U) radio access technology, or NR technology in an unlicensed band (NR-U) such as the 5 GHz ISM band. Operations in unlicensed spectrum may include downlink transmissions, uplink transmissions, sidelink transmissions, peer-to-peer transmissions, or a combination of these. Duplexing in unlicensed spectrum may be based on frequency division duplexing (FDD), time division duplexing (TDD), or a combination of both.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For instance, one or more base station antennas or antenna arrays may be co-located at an antenna assembly, such as an antenna tower. In some aspects, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for instance, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For instance, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For instance, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some aspects, the beam direction associated with transmissions along a single beam direction may be determined based on a signal that was transmitted in one or more beam directions. For instance, a UE 115 may receive one or more of the signals transmitted by the base station 105 in different directions and may report to the base station 105 an indication of the signal that the UE 115 received with a highest signal quality or an otherwise acceptable signal quality.

In some aspects, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For instance, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A UE 115 in wireless communications system 100 may be able to communicate directly with other UEs 115 over a sidelink connection (e.g., using a peer-to-peer (P2P) or device-to-device (D2D) protocol). Such communications may be referred to as D2D or sidelink communications. One or more of a group of UEs 115 utilizing sidelink communications may be within the geographic coverage area 110 of a base station 105. In some cases, other UEs 115 in such a group may be outside the geographic coverage area 110 of the base station 105 or may be otherwise unable to receive transmissions from the base station 105. In such cases, the UEs 115 within the geographic coverage 110 of the base station 105 may relay communications between the base station 105 and the UEs 115 outside the geographic area 110 of the base station 105. UEs 115 communicating via sidelink communications may utilize a one-to-many (1:M) system in which each UE 115 transmits to every other UE 115 in the group.

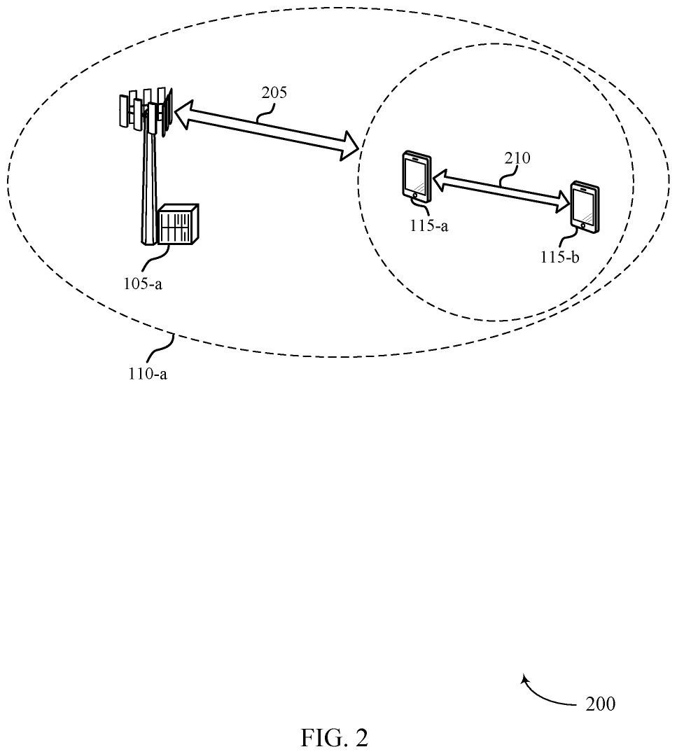

FIG. 2 illustrates an example of a wireless communications system 200 that supports S-SSB transmissions in a shared spectrum in accordance with aspects of the present disclosure. In some aspects, the wireless communications system 200 may implement aspects of wireless communication system 100.

The wireless communications system 200 includes a base station 105-a, which may be an example of a base station 105 described with reference to FIG. 1. The wireless communications system 200 also includes a UE 115-a and a UE 115-b, which may be examples of UEs 115 described with reference to FIG. 1. Base station 105-a may provide communications coverage for geographic coverage area 110-a, which may be an example of a geographic area 110 described with reference to FIG. 1. The base station 105-a may communicate with the UE 115-a and the UE 115-b on resources of a carrier 205, and the UE 115-a may communicate with the UE 115-b on resources of a carrier 210.

Communications between the UE 115-a and the UE 115-b (e.g., direct communications) may be referred to as sidelink communications. In some cases, the base station 105-a may schedule resources for communications between the UE 115-a and the UE 115-b (e.g., in a first resource allocation mode). In other cases, the UE 115-a or the UE 115-b may identify resources for communications with each other without the involvement of the base station 105-a (e.g., in a second resource allocation mode). In some aspects, the UE 115-a may serve as an anchor UE (e.g., an anchor node, a mini gNB, configured to transmit an S-SSB under some RSRP criterion) with PC5 channels and may schedule resources for communication by the UE 115-b (which may also be referred to as a client UE).

The wireless communications system 200 may support efficient techniques for facilitating S-SSB transmissions in a shared spectrum. Using the techniques described herein, the UE 115-a may efficiently transmit (e.g., beam sweep) multiple S-SSBs in the shared spectrum. The UE 115-b may then receive the one or more S-SSBs. In one aspect, the UE 115-a may transmit S-SSBs in one or more S-SSB bursts in an S-SSB period to improve the chances that the UE 115-b may receive the S-SSBs.

According to aspects described herein, the UE 115-a may dynamically configure a set of S-SSB block instances. The UE 115-a may identify a configuration of the S-SSB instances based on a configuration message from the base station 105-a. The configuration may include a first quantity of S-SSB instances (e.g., an initial quantity based on the configuration) for a S-SSB period. In an aspect, the UE 115-a may determine a second quantity of S-SSB instances and transmit the second quantity of S-SSB instances over a second S-SSB period. In some aspects, the UE 115-a may determine the second quantity of S-SSB instances by determining a subsampling of S-SSBs associated with the first quantity of S-SSB instances. Using these techniques, a UE may mitigate or reduce unnecessary overhead when beam sweeping multiple S-SSBs in the shared spectrum.

In some aspects, the UE 115-a may determine the second quantity of S-SSB instances based on an orientational movement of the UE 115-a (e.g., over one or more S-SSB periods). In an aspect, the UE 115-a may determine the second quantity of S-SSB instances (e.g., the subsampling of S-SSBs associated with the first quantity of S-SSBs) based on the orientational movement satisfying a threshold. The UE 115-a may determine the orientational movement of the UE 115-a using an orientation sensor included in or coupled to the UE 115-a. The orientation sensor may be a multiple axis orientation sensor. In some aspects, the orientation sensor may include a combination of multiple axis (e.g., 3-axis) acceleration sensors, multiple axis (e.g., 3-axis) gyroscope sensors, and multiple axis (e.g., 3-axis) geomagnetic sensors.

Techniques described herein may support improved sidelink communications between the UE 115-a and the UE 115-b. The UE 115-a may configure a sidelink beam selection resource pool based on transmitting a S-SSB burst. The UE 115-b may select a set of preferred beams based on S-SSBs transmitted in the S-SSB burst and communicate the selection to the UE 115-a over a physical sidelink shared channel transmission (PSSCH). The UE 115-b may indicate the beam selection via SCI (e.g., an SCI-2 format which may be in PSSCH scheduled by SCI-1 in the PSCCH). In some aspects, the UE 115-b may indicate the beam indices for the preferred beams, RSRP measurements for the preferred beams, source identifier, destination identifier, whether a beam confirmation (e.g., an acknowledgement (ACK)) is triggered, or a new data indicator (NDI) and hybrid automatic repeat request identifier (HARQ ID) if used to schedule a data transmission.

The UE 115-a may acknowledge the preferred beams in a PSFCH. In some aspects, the UE 115-b may send SCI-2 without additional data, in which case the UE 115-b may include the SCI-2 in a subset of the PSSCH resources scheduled by the SCI-1. The UE 115-b may rate match using the rest of the PSSCH resources, or in some aspects, rate match only the last symbol of the SCI-2 (e.g., not transmitting over the other PSSCH resources). In some aspects, the UE 115-b may preserve the DMRS symbol of the PSSCH, such that an ending symbol for transmission is at least after the first DMRS.

The UE 115-b may use resources of the PSFCH for transmission of beam selection information indicating the preferred beams. In an aspect, the PSFCHPSFCH may be divided into sets of resources associated with each beam of the S-SSB burst, and the beam selection information may be determined based on selected resources of the sets of resources. In some aspects, selection of a resource within a set of resources associated with a beam may indicate a client identifier of the UE 115-b to the UE 115-a. Using these techniques, a beam selection resource pool and beam selection information (e.g., preferred transmission beams) may be communicated between the UE 115-a and the UE 115-b with improved efficiency and reduced overhead.

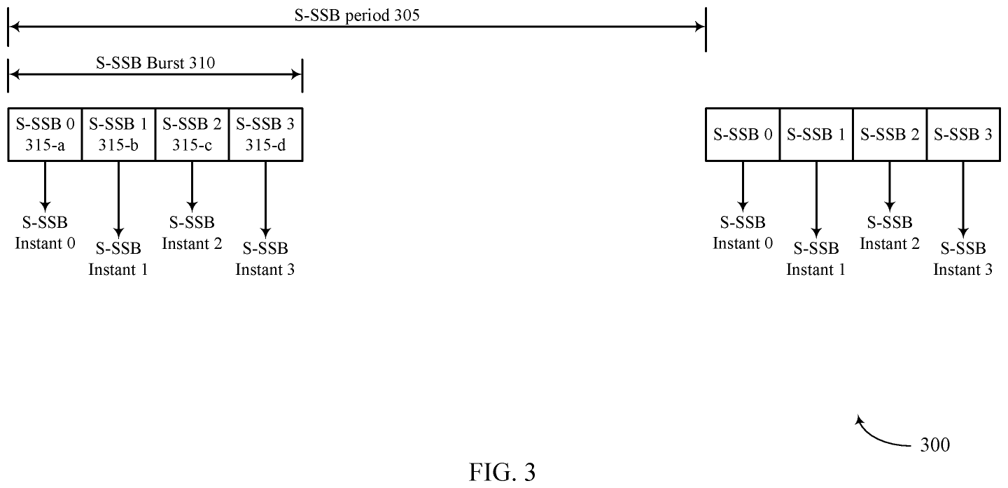

FIG. 3 illustrates an example of S-SSB transmissions 300 that support S-SSB transmissions in a shared spectrum in accordance with aspects of the present disclosure. In some aspects, the S-SSB transmissions 300 may be implemented by aspects of the wireless communication system 100 and the wireless communication system 200.

FIG. 3 illustrates aspects of techniques for efficiently transmitting S-SSBs in a shared spectrum in some wireless communications systems. In some wireless communications systems, a quantity of S-SSBs within one S-SSB period may be defined. An S-SSB period may correspond to a period of time allocated to a UE 115 for transmitting S-SSBs in a shared spectrum. For a subcarrier spacing of 15 kHz in FR1 (e.g., a low frequency band, such as a sub-6 GHz band), a UE 115 may transmit one S-SSB in a single slot. For a subcarrier spacing of 30 kHz in FR1, a UE 115 may transmit one S-SSB in a single slot or two S-SSBs in respective slots. For a subcarrier spacing of 60 kHz in FR1, a UE 115 may transmit one S-SSB in a single slot or two or four S-SSBs in respective slots. For a subcarrier spacing of 30 kHz in FR2 (e.g., a high frequency band, such as a mmW band), a UE 115 may transmit one S-SSB in a single slot or two, four, eight, 16, or 32 S-SSBs in respective slots. For a subcarrier spacing of 60 kHz in FR2, a UE 115 may transmit one S-SSB in a single slot or two, four, eight, 16, 32, or 64 S-SSBs in respective slots.

Thus, S-SSB beam sweeping may be possible with a limited number of beams (e.g., for a subcarrier spacing greater than or equal to 30 kHz in FR1). In some cases, to maximize the gains of performing a beam sweep, it may be appropriate to add more S-SSB slots (e.g., slots that include synchronization signal blocks (SSBs)) that are mapped to different beams. In some aspects, the maximum number of S-SSBs (K) within one S-SSB period may be increased (e.g., in FR1). For instance, the maximum number of S-SSBs within one S-SSB period may be increased to two (e.g., {1, 2}) for a subcarrier spacing of 15 kHz in FR1, to four (e.g., {1, 2, 4}) fora subcarrier spacing of 30 kHz in FR1, or to eight (e.g., {1, 2, 4, 8}) for a subcarrier spacing of 60 kHz. The above maximum numbers of S-SSBs are provided for the purposes of example, other maximum numbers may be used. Further, a UE 115 may be configured to transmit S-SSBs in contiguous time slots (e.g., with a sidelink time interval of zero). Because each S-SSB may occupy one slot, an S-SSB burst may occupy up to 2 ms. An S-SSB burst may correspond to a group of S-SSBs (e.g., S-SSB instants) each transmitted using a different beam.

In some instances, the maximum number of S-SSBs within one S-SSB period (e.g., 160 ms) may be increased (e.g., to 1, 2, 4, 8, 16, 32, or 64). In an aspect, the maximum number of S-SSBs within one S-SSB period may be increased to eight for a subcarrier spacing of 30 kHz to support orientational movement of the UE 115 with respect to a threshold (e.g., to support an orientational movement threshold such as rotations in tens of milliseconds, in the case of an industrial internet of things (IIoT) application).

In FIG. 3, a UE 115 may perform a listen-before-talk (LBT) procedure to gain access to a sidelink BWP for an S-SSB period 305 (e.g., 160 ms). The UE 115 may then identify an S-SSB burst 310 to transmit in the S-SSB period 305. The S-SSB burst 310 may include two or more S-SSBs 315, including S-SSB 315-a, S-SSB 315-b, S-SSB 315-c, and S-SSB 315-d. The UE 115 may then transmit each of the two or more S-SSBs 315 of the S-SSB burst 310 using a different beam in the S-SSB period 305. That is, the beam sweep of the S-SSBs 315 may correspond to using a different beam to transmit each of the S-SSBs 315 in the S-SSB burst 310. Further, the S-SSBs 315 in the S-SSB burst 310 may be transmitted in contiguous time resources. That is, a UE 115 may transmit the S-SSBs 315 in the S-SSB burst 310 with a sidelink time interval of zero such that there are no gaps in the S-SSB burst 310. By avoiding gaps in the S-SSB burst 310, the UE 115 may prevent other UEs from gaining access to a sidelink channel for transmissions when the UE 115 is using the sidelink channel.

In some cases, in addition to transmitting an S-SSB burst with multiple S-SSBs in an S-SSB period, it may be beneficial for a UE 115 to transmit even more S-SSBs in an S-SSB period to increase the likelihood that other UEs will be able to discover the UE 115.

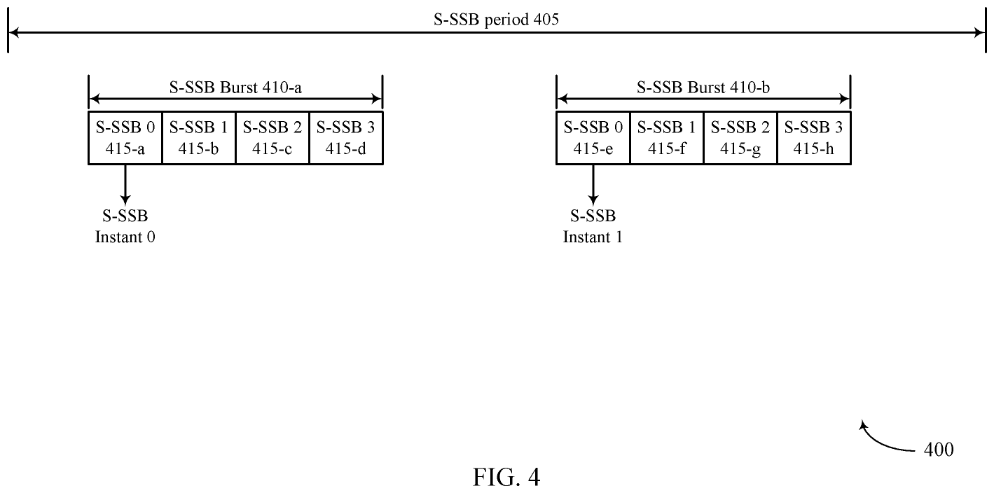

FIG. 4 illustrates an example of S-SSB transmissions 400 that support S-SSB transmissions in a shared spectrum in accordance with aspects of the present disclosure. In some aspects, S-SSB transmissions 400 may be implemented by aspects of the wireless communication system 100 and the wireless communication system 200. FIG. 4 illustrates aspects of S-SSB transmissions 400 in a beam sweep in accordance with some techniques for S-SSB transmissions. As illustrated, a UE 115 may transmit multiple S-SSB bursts 410 in an S-SSB period 405. For instance, a wireless communications system may allow multiple contiguous S-SSB slots (e.g., S-SSB instances) in each S-SSB burst to sweep the beams, and multiple S-SSB bursts in each S-SSB period. Each S-SSB slot in an S-SSB burst may be transmitted with a different beam (e.g., from the beams used to transmit other S-SSB slots in the S-SSB burst). Further, each S-SSB burst may include a same or different beam sweep (e.g., a first S-SSB burst with S-SSBs transmitted with a first set of beams and a second S-SSB burst with S-SSBs transmitted with a second set of beams). In some aspects, for a subcarrier spacing of 30 kHz, there may be four S-SSB slots within one S-SSB burst (e.g., which sweeps up to four beams), and there may be up to two S-SSB bursts within an S-SSB period (e.g., 160 ms).

In some instances, the maximum number of S-SSBs within one S-SSB period (e.g., 160 ms) may be increased (e.g., to 1, 2, 4, 8, 16, 32, or 64). In an aspect, the maximum number of S-SSBs within one S-SSB period may be increased to eight for a subcarrier spacing of 30 kHz to support orientational movement of the UE 115 with respect to a threshold (e.g., to support an orientational movement threshold such as rotations in tens of milliseconds, in the case of an industrial internet of things (IIoT) application).

In FIG. 4, a UE 115 may perform an LBT procedure to gain access to a sidelink BWP in a shared spectrum for an S-SSB period 405. The UE 115 may then identify multiple S-SSB bursts 410 (e.g., S-SSB burst 410-a and S-SSB burst 410-b) to transmit in the S-SSB period 405. Each S-SSB burst may include two or more S-SSBs 415. For instance, S-SSB burst 410-a may include S-SSB 415-a, S-SSB 415-b, S-SSB 415-c, and S-SSB 415-d, and S-SSB burst 410-b may include S-SSB 415-e, S-SSB 415-f, S-SSB 415-g, and S-SSB 415-h. The UE 115 may then transmit each of the two or more S-SSBs 415 in each S-SSB burst 410 using a different beam in the S-SSB period 405. That is, the beams used to transmit S-SSBs 415 in each S-SSB burst 410 may be the same or different. The UE 115 may also select a sidelink time interval for each of the multiple S-SSB bursts 410 such that the multiple S-SSB bursts 410 are non-overlapping in the S-SSB period. That is, the time interval between two S-SSBs 415 may be chosen such that S-SSB bursts 410 are non-overlapping.

In some cases, a base station 105 may configure a UE 115 to transmit a particular number of S-SSB bursts in an S-SSB period. For instance, the base station 105 may transmit an indication of a number (e.g., quantity) of S-SSB bursts for the UE 115 to transmit in an S-SSB period. In FIG. 3, the base station 105 may transmit an indication for the UE 115 to transmit one S-SSB burst in an S-SSB period, and, in FIG. 4, the base station 105 may transmit an indication for the UE 115 to transmit two S-SSB bursts in an S-SSB period. In some aspects, the base station 105 may transmit an indication for the UE 115 to transmit more than two S-SSB bursts (e.g., eight S-SSB bursts) in an S-SSB period (e.g., eight S-SSB bursts in a S-SSB period of 160 ms). In other cases, a UE 115 may be preconfigured with a number of S-SSB bursts to transmit in an S-SSB period (e.g., installed in the profile of the UE 115). Further, when a UE 115 transmits an S-SSB in a slot, the UE 115 may transmit a master information block (MIB) with the S-SSB. The UE 115 may also transmit an indication of the slot index in the MIB, and the slot index may indicate the beam index of the beam used to transmit the S-SSB (e.g., after a receiving UE 115 decodes the payload of the MIB). That is, the slot index may be remapped to an S-SSB beam index if a receiving UE 115 is able to identify the S-SSB pattern.

Additionally, or alternatively, the UE 115 may transmit DMRSs with (e.g., within or alongside) an S-SSB, and the UE 115 may indicate a beam index of a beam used to transmit the S-SSB in the DMRS scrambling sequence (e.g., if the UE 115 is unable to identify the S-SSB pattern, as is the case for initial access). That is, the UE 115 may identify a beam for transmitting an S-SSB in an S-SSB burst, and the UE 115 may encode at least a portion of a DMRS scrambling sequence (e.g., two or three bits) included with the S-SSB based on a beam index of the identified beam. For instance, the UE 115 may set an initialization seed for the encoding as a function of the beam index of the identified beam. A receiving UE 115 may receive an S-SSB and a DMRS scrambling sequence with the S-SSB, and the receiving UE 115 may blind decode at least the portion of the DMRS scrambling sequence to identify a beam index of a beam used to transmit the S-SSB. For instance, the receiving UE 115 may perform blind decoding based on four or eight blind decoding hypotheses to determine the S-SSB beam index.

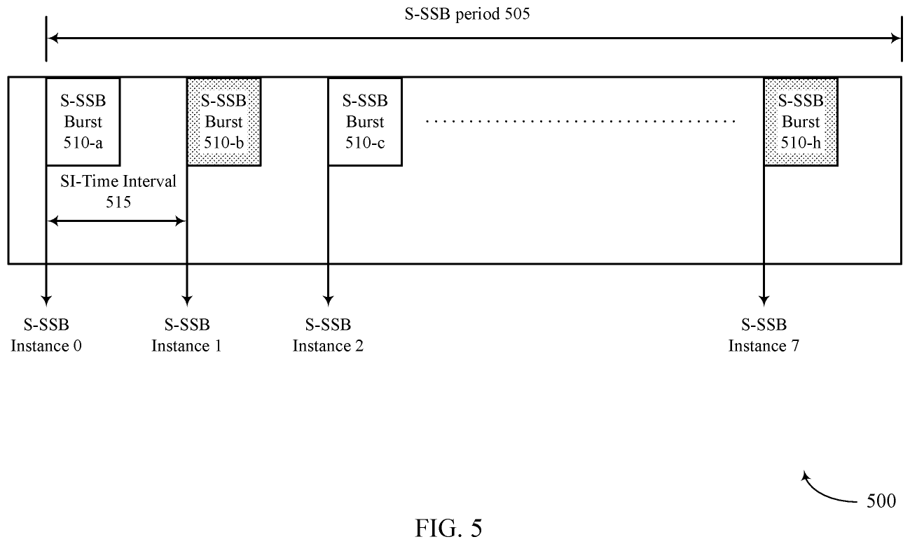

FIG. 5 illustrates an example of a S-SSB transmissions 500 that supports sidelink S-SSB transmissions in a shared spectrum in accordance with aspects of the present disclosure. In some aspects, the S-SSB transmissions 500 may be implemented by aspects of the wireless communication system 100 and the wireless communication system 200. As described herein, a UE 115 (e.g., the UE 115-a or the UE 115-b described with reference to FIG. 2) may increase the number of S-SSB bursts in an S-SSB period (e.g., based on an orientation movement threshold). In some cases, however, such techniques may introduce large overheads as a higher density of S-SSB instances are configured. Additionally, the higher density of S-SSB instances may contribute to increased amounts of S-SSB medium pollution.

According to examples of aspects described herein, the UE 115 may dynamically configure a set of S-SSB instances. In an aspect, the UE 115 may dynamically configure S-SSB instance 0 through S-SSB instance 7 associated with an S-SSB period 505. The UE 115 may identify a configuration of the S-SSB instances based on a message from the base station 105. The message may be indicated in a system information block (SIB), a MIB, radio resource control (RRC) signaling, and/or DCI. The configuration may include a first quantity of S-SSB instances (e.g., an initial quantity based on the configuration) for the S-SSB period 505. In the example illustrated in FIG. 5, the S-SSB period 505 is 160 ms, subcarrier spacing is 30 kHz, and a direct frame number (DFN) equal to zero.

The UE 115 may determine a second quantity of S-SSB instances and transmit the second quantity of S-SSB instances over a second S-SSB period (e.g., an S-SSB period following the S-SSB period 505). The second quantity of S-SSB instances may be different from (e.g., less than) the first quantity of S-SSB instances. In an aspect, the second quantity of S-SSB instances may include S-SSB instance 0, S-SSB instance 2, S-SSB instance 4, and S-SSB instance 6. In some aspects, the second quantity of S-SSB instances may include S-SSB instance 1, S-SSB instance 3, S-SSB instance 5, and S-SSB instance 7.

In some aspects, the UE 115 may determine the second quantity of S-SSB instances by determining a subsampling of S-SSBs associated with the first quantity of S-SSB instances. In some aspects, the UE 115 may determine the second quantity of S-SSB instances based on a subsampling factor. In some other aspects, the UE 115 may determine the second quantity of S-SSB instances based on an orientational movement of the UE 115-a over the S-SSB period 505. In some aspects, the subsampling factor may be inversely proportional to the orientational movement (e.g., a magnitude of the orientational movement) associated with the UE 115. The UE 115 may measure or detect the orientational movement using an orientation sensor as described herein.

In an aspect, the first quantity of S-SSB instances may include S-SSB instance 0 through S-SSB instance 7, and accordingly, the UE 115 may transmit an S-SSB burst 510 (e.g., an S-SSB instance) every 20 ms within the S-SSB period 505. In another aspect, the second quantity of S-SSB instances may include S-SSB instance 0, S-SSB instance 2, S-SSB instance 4, and S-SSB instance 6, and accordingly, the UE 115 may transmit an S-SSB burst 510 (e.g., an S-SSB instance) every 40 ms within the S-SSB period 505. In some aspects, the subsampling of S-SSBs associated with the first quantity of S-SSB instances may include S-SSBs associated with S-SSB instance 0, S-SSB instance 2, S-SSB instance 4, and S-SSB instance 6, and may exclude S-SSBs associated with S-SSB instance 1, S-SSB instance 3, S-SSB instance 5, and S-SSB instance 7. Each SSB instance may correspond to an SSB burst. The S-SSB bursts 510 may include examples of aspects of the S-SSB bursts 310 and S-SSB bursts 410 described with reference to FIGS. 3 and 4. The S-SSB instances 0 through 7 may include examples of aspects of the S-SSB instants described with reference to FIGS. 3 and 4.

The UE 115 may determine the first quantity of S-SSB instances based on a provision of orientational movement (e.g., a largest magnitude, highest acceleration, highest speed) of the UE 115 over the S-SSB period 505. The first quantity of S-SSB instances may be an initial configuration having a high density of S-SSB instances included in the S-SSB period 505, In an aspect, compared to the subsampling of S-SSB instances described herein. The UE 115 may receive the initial configuration in a message from the base station 105.

The UE 115 may transmit the first quantity of S-SSB instances or the second quantity of S-SSB instances based on the orientational movement over the S-SSB period 505 satisfying an orientational movement threshold (e.g., magnitude, acceleration, speed). In an aspect, the UE 115 may determine that an orientational movement of the UE 115 over the S-SSB period 505 satisfies (e.g., is greater than or equal to) the orientational movement threshold (i.e., high orientational movement). The UE 115 may transmit the first quantity of S-SSB instances over an S-SSB period following the S-SSB period 505 (e.g., transmit a relatively higher density of S-SSB instances). In another aspect, the UE 115 may determine that an orientational movement of the UE 115 over the S-SSB period 505 does not satisfy (e.g., is less than) the orientational movement threshold (e.g., low orientational movement), and the UE 115 may transmit the second quantity of S-SSB instances over an S-SSB period following the S-SSB period 505 (e.g., transmit a relatively lower density of S-SSB instances). Using these techniques, the UE 115 may improve the quality of sidelink communications with other UEs 115 (e.g., for cases in which the UE 115 detects orientational movement above an orientational movement threshold and transmits the first quantity of S-SSB instances) and mitigate or reduce unnecessary overhead (e.g., for cases in which the UE 115 detects orientational movement below an orientational movement threshold and transmits the second quantity of S-SSB instances) when beam sweeping multiple S-SSBs in the shared spectrum.

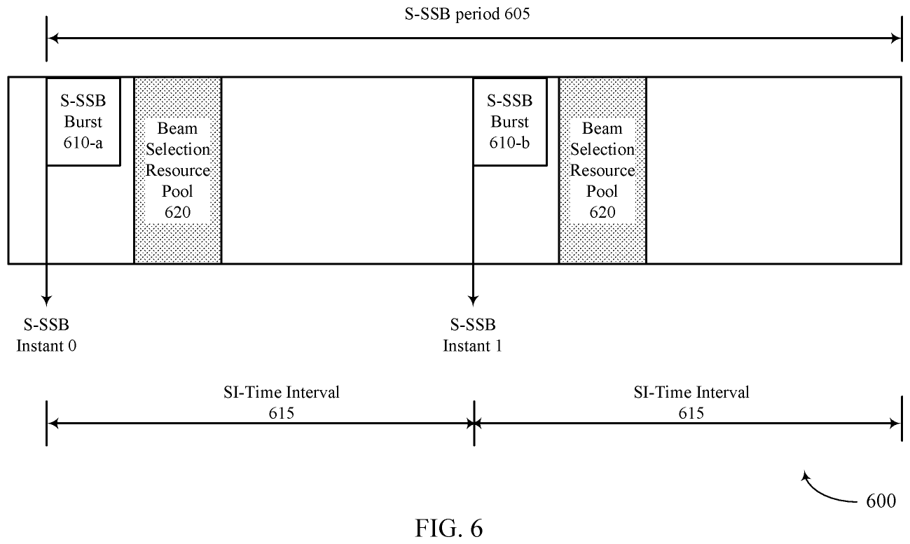

FIG. 6 illustrates an example of a S-SSB transmissions 600 that supports S-SSB transmissions in a shared spectrum in accordance with aspects of the present disclosure. In some aspects, the S-SSB transmissions 600 may be implemented by aspects of the wireless communication system 100 and the wireless communication system 200. As described herein, a UE 115 (e.g., the UE 115-a described with reference to FIG. 2, also referred to as an anchor UE) may communicate a beam selection resource pool 620 for sidelink communications between the UE 115 and another UE (e.g., the UE 115-b described with reference to FIG. 2, also referred to as a client UE). In some aspects, the beam selection resource pool 620 may be a sidelink beam selection resource pool. In some aspects, the beam selection resource pool 620 may be included in an initial access resource pool configured by the base station 105. The example illustrated in FIG. 6 is described with reference to the UE 115-a (e.g., an anchor UE) and the UE 115-b (e.g., a client UE) described with reference to FIG. 2.

The UE 115-a may transmit a S-SSB burst 610 (e.g., S-SSB burst 610-a, S-SSB burst 610-b) over a PSSCH using one or more beams in a S-SSB period 605. The S-SSB period 605 may be equal to 160 ms, in some cases. In the example described with reference to FIG. 6, the S-SSB burst 610 (e.g., S-SSB burst 610-a) may be transmitted based on a system information (SI)-time interval 615 of the S-SSB period 605. A DFN associated with the S-SSB period 605 may be equal to zero. The UE 115-a may identify a configuration for a set of resources of the beam selection resource pool 620 based on transmitting the S-SSB burst 610. The S-SSB bursts 610 may include examples of aspects of the S-SSB bursts 310, the S-SSB bursts 410, and the S-SSB bursts 510 described with reference to FIGS. 3 through 5. The S-SSB instances 0 and 1 may include examples of aspects of the S-SSB instances described with reference to FIGS. 3 through 5.

The UE 115-b may identify the S-SSB burst 610 and receive one or more S-SSBs included in the S-SSB burst 610 using the one or more beams associated with the S-SSB burst 610. In some aspects, the UE 115-b may select a set of preferred beams (e.g., from the beams associated with the S-SSB burst 610) for communicating sidelink data with the UE 115-a. In an aspect, the UE 115-b may select the set of preferred beams based on S-SSBs transmitted in the S-SSB burst 610. In some aspects, the UE 115-b may select the set of preferred beams based on criteria such as RSRP or reference signal received quality (RSRQ).

The UE 115-b may communicate the selection of the preferred beams (e.g., an indication of the preferred beams) to the UE 115-a in a control message over a PSSCH transmission using resources of the beam selection resource pool 620 associated with the S-SSB burst 610. In an aspect, the resources may be associated with the S-SSBs included in the S-SSB burst 610. The control message may include an indication of the preferred beams in a SCI format (e.g., SCI-2). In some aspects, the control message may include an indication of beam indices for the preferred beams, RSRP measurements (e.g., as measured by the UE 115-b) for the preferred beams, source identifier, destination identifier, whether a beam confirmation (e.g., an ACK) is triggered, or NDI and HARQ ID if used to schedule a data transmission.

The PSSCH transmission (e.g., the control message indicating the preferred beams) may be scheduled by PSCCH. In an aspect, the UE 115-b may transmit a control message to the UE 115-a in a PSCCH transmission. The control message in the PSCCH transmission may include scheduling information for the PSSCH transmission. In some aspects, the control message may use an SCI-1 format. In some other aspects, the control message may be a medium access control (MAC) control element (MAC-CE) transmitted in a PSSCH payload. In the examples described herein, the control message is described as being in the SCI-1 or SCI-2 format.

In an aspect, the control message in SCI-1 format (e.g., PSCCH transmission which includes scheduling information for the PSSCH transmission) may be referred to as a first second control message, and the control message in the SCI-2 format (e.g., the PSSCH transmission indicating the preferred beams) may be referred to as a second control message. In some aspects, the UE 115-b may set a priority for the second control message (e.g., set a priority for transmission of the SCI-2). The UE 115-b may indicate the priority in the first control message. The UE 115-b may transmit the second control message based on the priority. The UE 115-a may identify the priority of the second control message based on the indication in the first control message, and in some aspects, receive the second control message based on the priority.

In an aspect, the UE 115-b may set a high priority for a second control message to be transmitted (e.g., the second control message including a selection of preferred beams). The UE 115-b may transmit a first control message indicating the high priority of the second control message. In some aspects, other UEs 115 in the wireless communications system 200 (e.g., UEs 115 different from UE 115-a and UE 115-b) detecting the first control message may identify the high priority associated with the second control message, and in some aspects, may back off or postpone sending any transmissions at temporal instances which may interfere with the transmission of the second control message. In some aspects, the UE 115-a may consider any PSSCH transmission carrying beam selection information (e.g., SCI-2) to have a highest priority as part of channel occupancy ratio (CR) based congestion control.

In some other aspects, a high priority may be associated with the beam selection resource pool 620. In an aspect, the UE 115-b may transmit a first control message (e.g., SCI-1) indicating SCI-2 in the beam selection resource pool 620. Based on the indication, the UE 115-a may detect for SCI-2 in the beam selection resource pool 620. In some aspects, the number of packets and number of subchannels included in the beam selection resource pool 620 may be relatively small compared to an overall number of available packets and an overall number of subchannels.

In some aspects, the UE 115-a (and the UE 115-b) may be configured to operate in standalone sidelink mode. In an aspect, the UE 115-a may configure the beam selection resource pool 620 for all client UEs 115 (e.g., other UEs 115 configured for sidelink communication or having established sidelink communications with the UE 115-a) in remaining minimum system information (RMSI) or other system information blocks (SIBs). In some aspects, the beam selection resource pool 620 may be RRC configured by the base station 105 or indicated in a device profile associated with the UE 115-a (or UE 115-b).

The techniques described herein for communicating beam selection for sidelink communications may be advantageous over other techniques for communicating beam selection. In an aspect, in some alternative or additional aspects, the UE 115-a and the UE 115-b may utilize PRACH in sidelink communications (e.g., over a PC5 interface). In some cases, PRACH resources may correspond to S-SSB beams, and the UE 115-b may choose a PRACH resource to indicate a preferred transmit beam (e.g., a beam for the UE 115-a that transmitted the S-SSB to use for transmissions to the UE 115-b). Such techniques utilizing PRACH resources to indicate the preferred transmit beam may be inefficient compared to using PSSCH resources, however, based on compatibility with sidelink waveform formats. In some cases, the techniques described herein using PSSCH resources may be more efficient compared to the number of operations associated with a RACH procedure, and accordingly, may reduce latency and improve spectral efficiency.

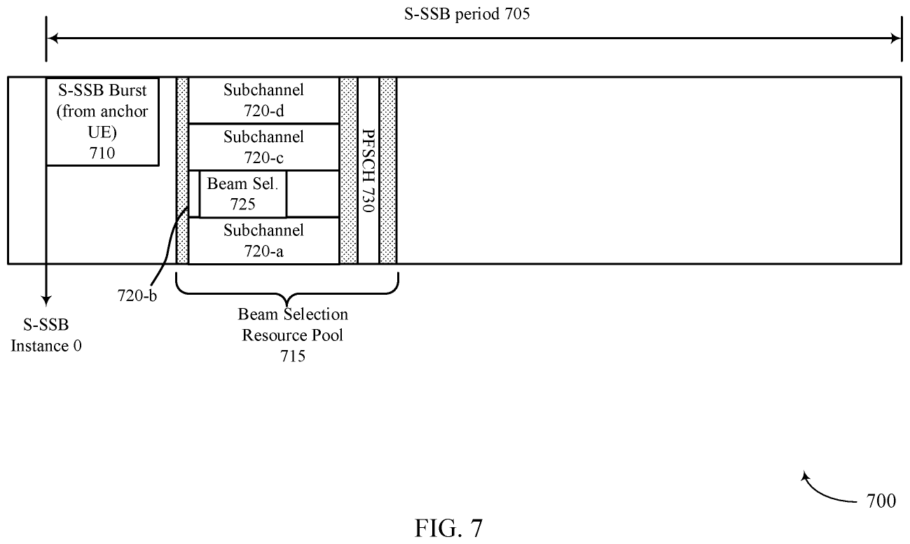

FIG. 7 illustrates an example of S-SSB transmissions 700 that support S-SSB transmissions in a shared spectrum in accordance with aspects of the present disclosure. In some aspects, the S-SSB transmissions 700 may be implemented by aspects of the wireless communication system 100 or the wireless communication system 200. FIG. 7 illustrates an example of beam management by a UE 115 (e.g., the UE 115-a described with reference to FIG. 2, also referred to as an anchor UE) based on an S-SSB burst 710 and beam selection resource pool 715 communicated by the UE 115 to another UE 115 (e.g., the UE 115-b described with reference to FIG. 2, also referred to as a client UE). The S-SSB burst 710 may include examples of aspects of the S-SSB bursts 310, the S-SSB bursts 410, or the S-SSB bursts 510, or the S-SSB bursts 610 described with reference to FIGS. 3 through 6. The beam selection resource pool 715 may include examples of aspects of the beam selection resource pools 620 described with reference to FIG. 6. In an aspect, the beam selection resource pool 715 may be associated with the S-SSB burst 710. The example illustrated in FIG. 7 is described with reference to the UE 115-a (e.g., an anchor UE) and the UE 115-b (e.g., a client UE) described with reference to FIG. 2.

The UE 115-b may communicate the selection of preferred beams (e.g., an indication of the preferred beams) to the UE 115-a in a control message (e.g., in SCI-2 format) over a PSSCH transmission using a resource (or resources) of a set of resources of the beam selection resource pool 715. The set of resources of the beam selection resource pool 715 may be associated with S-SSBs included in the S-SSB burst 710. In some aspects, the resource for indicating the selection of the preferred beams may indicate a client identifier of the UE 115-b. In some aspects, the indication of a preferred beam (or beams) may include an acknowledgement trigger for transmitting an acknowledgement indicator (e.g., ACK/NACK) corresponding to the preferred beam (or beams).

In an aspect, the UE 115-b may indicate a beam selection on resources of a frequency subchannel included in the beam selection resource pool 715. In an aspect, the UE 115-b may indicate a beam selection 725 (e.g., for a preferred beam or beams) using a subset of resources of any of subchannel 720-a through subchannel 720-d (which may also be referred to herein as subchannels #0 through subchannel #4). In the example illustrated in FIG. 7, the UE 115-b may use the subset of resources of the subchannel 720-b to indicate the beam selection 725. In some aspects, the UE 115-b may select the subset of resources of the subchannel 720-b based on a pseudo-random determination of resources and subchannels included among subchannel 720-a through subchannel 720-d.

The UE 115-b may use resources of a PSFCHPSFCH 730 for communicating beam selection information indicating preferred beams. The PSFCHPSFCH 730 may be included in the beam selection resource pool 715. In some aspects, the UE 115-b transmit a positive acknowledgement (ACK) indicator over a set of PSFCH resources (e.g., PSFCH resource blocks) included in the set of resources for the beam selection resource pool 715. In an aspect, the UE 115-b may indicate preferred beams (e.g., beam selection information indicating preferred beams) using a positive acknowledgement (ACK) indicator in PSFCH resources of the PSFCH 730. In an aspect, the PSFCH 730 may be divided into sets of PSFCH resources (e.g., PSFCH resource blocks) associated with each beam of the S-SSB burst 710.

In some aspects, the UE 115-a and UE 115-b may divide the number of PSFCH resource blocks include in the PSFCH 730 by the number of S-SSB beams associated with the S-SSB burst 710. A set of PSFCH resource blocks may be referred to as an interlace. In an aspect, a first S-SSB beam of the S-SSB beams may map to a first set of PSFCH resource blocks (interlaces). Each S-SSB beam of the S-SSB beams associated with the S-SSB burst 710 may be associated with M_{beam,slot}^{PSFCH} resource blocks (interlaces). In some aspects, for each S-SSB beam, the number of PSFCH resources may be configured (e.g., by the wireless communications system 200 or the base station 105-a) based on the equation R_{PRB,CS}^{PSFCH}=N_{CS}^{PSFCH}×M_{beam,slot}^{PSFCH}, where N_{CS}^{PSFCH}) is the number of cyclic shift (CS) pairs, configured per resource pool.

In some aspects, the PSFCH resources of the PSFCH 730 may be configured (e.g., by the wireless communications system 200, In an aspect, by the base station 105-a) based on an identifier of the UE 115-1) (e.g., a client UE identifier) and an identifier of the UE 115-a (e.g., an anchor UE identifier). In an aspect, the PSFCH resources (of the PSFCH 730) over which to transmit the positive acknowledgement (ACK) indicator may be configured by using the equation (P_{ID}+M_{ID})mod R_{PRB,CS}^{PSFCH}, where M_{ID} is the identifier of the TIE 115-b (e.g., client UE identifier), P_{ID} is the identifier of the UE 115-a (e.g., anchor UE identifier).

In some other aspects, the PSFCH 730 may be configured (e.g., by the wireless communications system 200, by the base station 105-a) according to a different PSFCH format which supports an additional number of bits (e.g., an additional number of bits for communicating an acknowledgement indicator). The different PSFCH format may be an enhanced PSFCH format (e.g., format 1, format 2, format 3). In an aspect, for each S-SSB beam, the number of PSFCH resources may be configured based on the equation R_{PRB,CS}^{PSFCH}=N_{bitPerRB}^{PSFCH}×M_{beam,slot}^{PSFCH}, where N_{bitPerRB}^{PSFCH} is the number of bits of the different PSFCH format per resource block (interlace), configured per resource pool. In some aspects, the different PSFCH format may be applied in cases of a PSFCH interlaced waveform in which each interlace has ten resource blocks. In an aspect, the different PSFCH format may carry over a different phase ramp among resource block clusters or payload among resource elements.

In some cases, collisions may occur among different client UEs 115 on the preferred beams indicated (e.g., signaled) by the UE 115-b. Collisions may occur due to constraints associated with the number of resource blocks (interlaces) (e.g., PSFCH resources may be overloaded). According to some aspects, the UE 115-a may transmit using the preferred beams in initial PSSCH slots associated with the preferred beams until detecting a positive ACK. Such techniques may be beneficial for cases in which the UE 115-a is to transmit a long burst of PSSCH slots to client UEs 115 (e.g., the UE 115-b and other client UEs 115), such as with enhanced mobile broadband (eMBB). In some aspects, the UE 115-a may test transmissions for a configured first number of slots of PSSCH (e.g., the first three slots), using different preferred beams indicated (e.g., signaled) by PSFCH. Accordingly, the UE 115-a may transmit a minimal amount of data (e.g., a few slots of data), and confirm slots based on detecting a positive ACK associated with the slots.

The techniques described herein for configuring the PSFCH 730 (e.g., configuring the PSFCH resources of the PSFCH 730) may be advantageous over some other techniques for configuring PSFCH in a resource pool. Such other techniques may map PSSCH and a corresponding PSFCH resource based on parameters such as a starting sub-channel of PSSCH, a slot containing PSSCH, a source identifier, and a destination identifier.

According to some aspects, the UE 115-a may identify used resources of the sets of resources of the PSFCH 730 and determine beam selection information based on the used resources. Accordingly, the UE 115-a may receive signaling on a resource included in the PSFCH 730, where the resource corresponds to an S-SSB (e.g., the resource is mapped to the S-SSB), and the UE 115-a may determine that a beam used to transmit the S-SSB is the preferred beam. In some aspects, the UE 115-a may transmit an acknowledgement indicator (e.g., ACK/NACK) to the UE 115-b on unused resources of the set of resources of the PSFCH 730, using one or more preferred beams of the UE 115-b. In an aspect, the UE 115-a may transmit the acknowledgement indicator using a preferred beam indicated by the UE 115-b (e.g., In an aspect where the UE 115-b indicates one preferred beam).

In another aspect, the UE 115-a may select a beam from a set of preferred beams indicated by the UE 115-b and transmit the acknowledgement indicator using resources of the set of resources of the PSFCH 730 and the selected beam(s). In an aspect, the UE 115-a may determine the resources for transmitting the acknowledgement indicator using the equation (P_{ID}+M_{ID} beam index)mod R_{PRB,CS}^{PSFCH}. In the equation, M_{ID} is the identifier of the UE 115-b (e.g., client UE identifier), P_{ID} is the identifier of the UE 115-a (e.g., anchor UE identifier), and beam_index is a beam index associated with the beam selected by the UE 115-a. The UE 115-a may transmit sidelink data (e.g., a forward link transmission) to the UE 115-b using the selected beams described herein (e.g., using preferred beam indicated by the UE 115-b, using a beam selected by the UE 115-a from a set of preferred beams indicated by the UE 115-b).

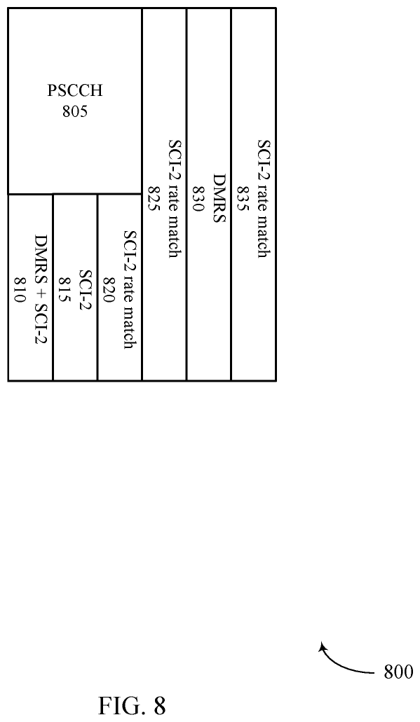

FIG. 8 illustrates an example 800 of a PSCCH transmission (e.g., first control message including SCI-1) and a PSSCH transmission (e.g., second control message including SCI-2) that support S-SSB transmissions in a shared spectrum in accordance with aspects of the present disclosure. In some aspects, the example 800 may be implemented by aspects of the wireless communication system 100 and the wireless communication system 200. The PSCCH transmission and the PSSCH transmission may be transmitted by a UE 115 (e.g., the UE 115-b described with reference to FIG. 2, also referred to as a client UE) to another UE 115 (e.g., the UE 115-a described with reference to FIG. 2, also referred to as an anchor UE). The example illustrated in FIG. 8 is described with reference to the UE 115-a (e.g., an anchor UE) and the UE 115-b (e.g., a client UE) described with reference to FIG. 2.

In some aspects, the UE 115-b may transmit SCI-2 without additional data, such that the SCI-2 may be included in a subset of PSSCH resources scheduled by the SCI-1 (e.g., indicated by DMRS+SCI-2 810 and SCI-2 815). In some aspects, the UE 115-b may rate match remaining resource elements of the PSSCH resources (e.g., indicated by SCI-2 rate match 820, SCI-2 rate match 825, and SCI-2 rate match 835). In an aspect, the PSSCH may have a default of at least seven symbols, and the UE 115-b may map the SCI-2 around a first DMRS symbol (e.g., DMRS 830) of the at least seven symbols. In an aspect, the UE 115-b may rate match remaining resource elements of a last symbol of the SCI-2 of the PSSCH, which may be more efficient and result in less interference compared to rate matching the SCI-2 to the entire PSSCH. In an aspect, the UE 115-b may suppress transmission of a PSCCH transmission for a subset of resources of a slot of the PSSCH.

In some aspects, the UE 115-b may include a codepoint or field in the first control message (e.g., in the SCI-1) for indicating the exclusion of additional data. In an aspect, the codepoint or field may indicate a set of unused resources of the PSSCH. In some aspects, the UE 115-b may indicate the exclusion of additional data using a set of reserved fields in a modulation and coding scheme (MCS) index. In some other aspects, the UE 115-b may indicate the exclusion of additional data using one or more of a set of reserved bits. In some aspects, the UE 115-b may transmit a shortened PSSCH transmission (e.g., a smaller number of PSSCH symbols such as two to four symbols of a PSSCH with a default length of seven symbols or more).

In some aspects, the reserved fields and the reserved bits may provide the UE 115-a with additional time and information regarding the resource mapping for processing the PSSCH. In some aspects, the UE 115-a may transmit an ACK indicator associated with the preferred beams, using a subset of resources of the slot of the PSSCH that is exclusive of the PSSCH transmission. In an aspect, the UE 115-a may decode the PSSCH transmission, and accordingly, transmit the acknowledgment indicator in a PSFCH which is within the same slot and exclusive of the PSSCH transmission.

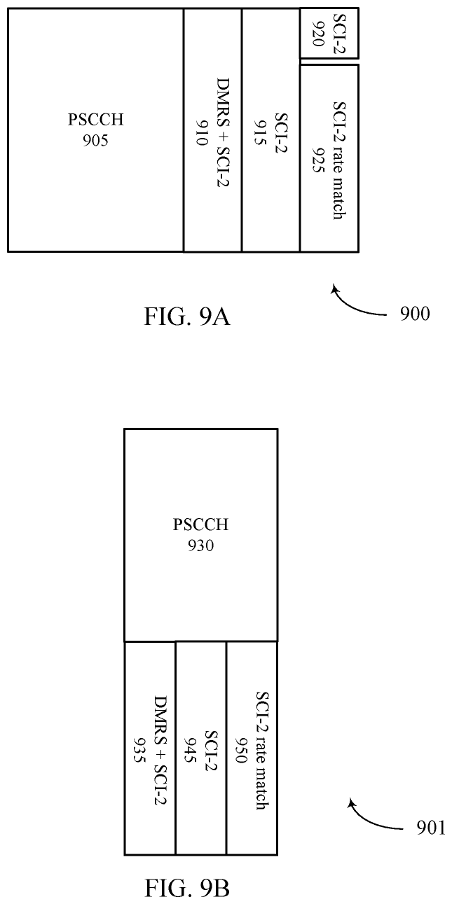

FIGS. 9A and 9B illustrate examples 900 and 901 of a PSCCH transmission (e.g., first control message including SCI-1) and a PSSCH transmission (e.g., second control message including SCI-2) that support S-SSB transmissions in a shared spectrum in accordance with aspects of the present disclosure. In some aspects, the examples 900 and 901 may be implemented by aspects of the wireless communication system 100 and the wireless communication system 200.

The PSCCH transmission and the PSSCH transmission may be transmitted by a UE 115 (e.g., the UE 115-b described with reference to FIG. 2, also referred to as a client UE) to another UE 115 (e.g., the UE 115-a described with reference to FIG. 2, also referred to as an anchor UE). The examples illustrated in FIGS. 9A and 9B are described with reference to the UE 115-a (e.g., an anchor UE) and the UE 115-b (e.g., a client UE) described with reference to FIG. 2. FIGS. 9A and 9B illustrates examples of SCI-2 transmitted without additional data, in which the SCI-2 is included in a subset of PSSCH resources scheduled by the SCI-1.

The examples 900 and 901 illustrate example aspects of a shortened PSSCH symbols and rate matching SCI-2 on remaining PSSCH resource elements. In some aspects, the UE 115-b may preserve the first DMRS symbol of the PSSCH (e.g., the first PSSCH symbol carrying DMRS, indicated by DMRS+SCI-2 910 or DMRS+SCI-2 935), such that an ending symbol for transmission may be at least after the first DMRS. In an aspect, the SCI-2 may be mapped to PSSCH resources (e.g., resource elements) starting from the first DMRS symbol of the PSSCH. In an aspect, the SCI-2 may be included in SCI-2 915, SCI-2 920, and SCI-2 945.

The UE 115-b may pad or rate match resource elements following SCI-2 920 (e.g., a last symbol in a slot containing SCI-2) or SCI-2 945. The padded or rate matched resource elements may be included in SCI-2 rate match 925 or SCI-2 rate match 950. In some aspects, rate matching the remaining resource elements of the last symbol may maintain phase continuity of PSCCH or SCI-2

In some aspects, the shortened PSSCH may be explicitly indicated in SCI-1 (e.g., the first control message as described herein). Aspects of the shorter PSSCH may be beneficial for serving multiple client UEs 115 using a mini-slot resource pool. The techniques described herein may be applied to PSSCH waveforms and time division multiplexing (TDM) interlaced PSSCH waveforms.

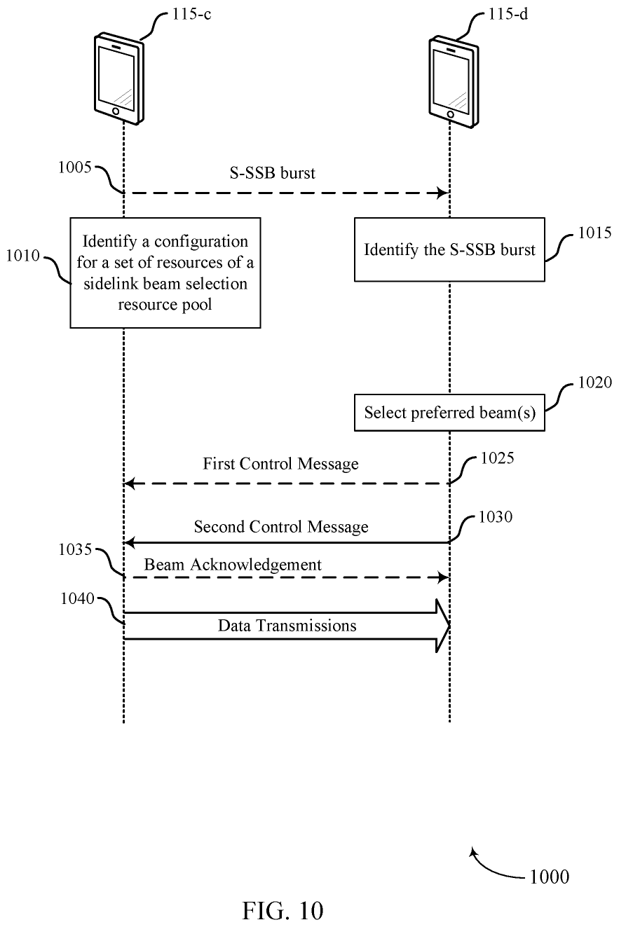

FIG. 10 illustrates an example of a process flow 1000 that supports S-SSB transmissions in a shared spectrum in accordance with aspects of the present disclosure. In some aspects, the process flow 1000 may implement aspects of wireless communication system 100 and the wireless communications system 200 described with reference to FIG. 1 and FIG. 2, respectively. The process flow 1000 may be based on a configuration by a base station 105 or a UE 115. In some aspects, the process flow 1000 may be implemented by the UE 115, for reduced power consumption, decreased or eliminated interference, and may promote improved link quality, higher reliability, and lower latency for sidelink communications, among other benefits.

The process flow 1000 may include a UE 115-c (e.g., an anchor UE) and a UE 115-d (e.g., a client UE), which may be examples of UE 115-a and UE 115-b, as described with reference to FIGS. 1 and 2. In the following description of the process flow 1000, the operations between the UE 115-c and the UE 115-d may be transmitted in a different order than the example order shown, or the operations performed by the UE 115-c and the UE 115-d may be performed in different orders or at different times. Some operations may also be omitted from the process flow 1000, and other operations may be added to the process flow 1000.

At 1005, the UE 115-c may transmit a S-SSB burst using one or more beams in a S-SSB period.

At 1010, the UE 115-c may identify a configuration for a set of resources of a sidelink beam selection resource pool based on transmitting the S-SSB burst.

At 1015, the UE 115-d may identify the S-SSB burst transmitted using one or more beams in the S-SSB period. In aspects, the UE 115-c may transmit multiple beams over the S-SSB burst at 1005 (e.g., within an S-SSB period) and the UE 115-d may receive and identify at least a subset of the multiple beams associated with the S-SSB burst.

At 1020, the UE 115-d may select one or more preferred beams of the subset of beams based on receiving the subset of beams associated with the S-SSBs.

In some aspects, the UE 115-d may transmit a control message including an indication of the one or more preferred beams (e.g., for receiving sidelink data) to the UE 115-c, over a resource of a set of resources of a sidelink beam selection resource pool, where the set of resources of the sidelink beam selection resource pool is associated with the S-SSB burst. The control message may include a beam index associated with the one or more preferred beams, a reference signal received power value associated with the one or more preferred beams, a source identifier associated with UE 115-c, a destination identifier associated with UE 115-d, a trigger associated with transmitting an acknowledgement indicator corresponding to the one or more preferred beams, a new data indicator, a hybrid automatic repeat request identifier, or a combination thereof. In an aspect, at 1025, the UE 115-d may transmit a first control message in a PSCCH. At 1030, the UE 115-d may transmit a second control message in a PSSCH, where the second control message includes the indication. The UE 115-d may rate match a control format (e.g., SCI-2) within the symbols of the PSSCH, or within a subset of the symbols of the PSSCH (e.g., rate-matching a last symbol with SCI-3 information, and suppressing transmission for the remaining symbols).

In some aspects the UE 115-d may transmit the control message over resources of a PSFCH, where the resources are selected based on the one or more preferred beams. The UE 115-d may additionally select the resources based on an ID of the transmitter (e.g., UE 115-c) or an ID of the receiver (e.g., UE 115-d).

At 1035, the UE 115-c may transmit an acknowledgement for the preferred beams (e.g., over a PSFCH).

At 1040, the UE 115-c may transmit sidelink data to the UE 115-d using the one or more preferred beams. Alternatively, at 1040, the UE 115-d may transmit sidelink data to the UE 115-c using the one or more preferred beams (e.g., based on resources indicated in the second control message).

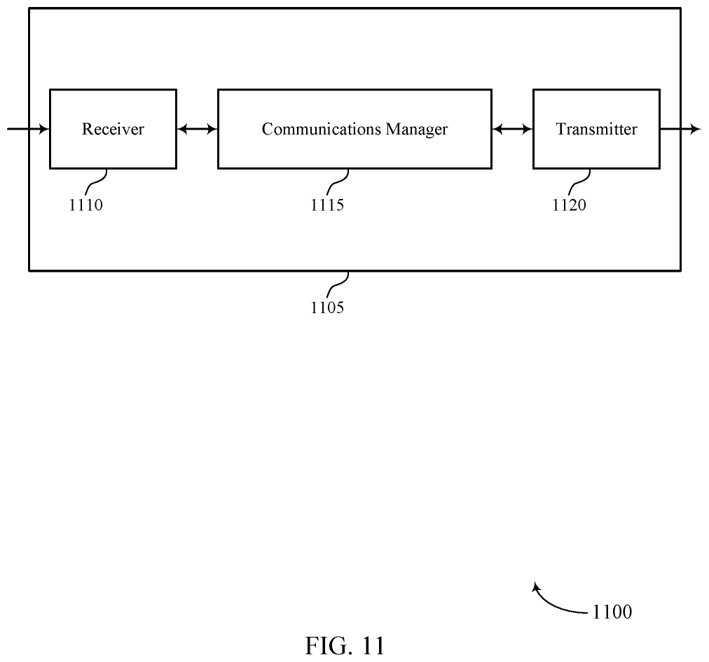

FIG. 11 shows a block diagram 1100 of a device 1105 that supports S-SSB transmissions in a shared spectrum in accordance with aspects of the present disclosure. The device 1105 may be or include aspects of a UE 115 as described herein. The device 1105 may include a receiver 1110, a communications manager 1115, and a transmitter 1120. The device 1105 may also include a processor. Each of these components may be in communication with one another (e.g., via one or more buses).

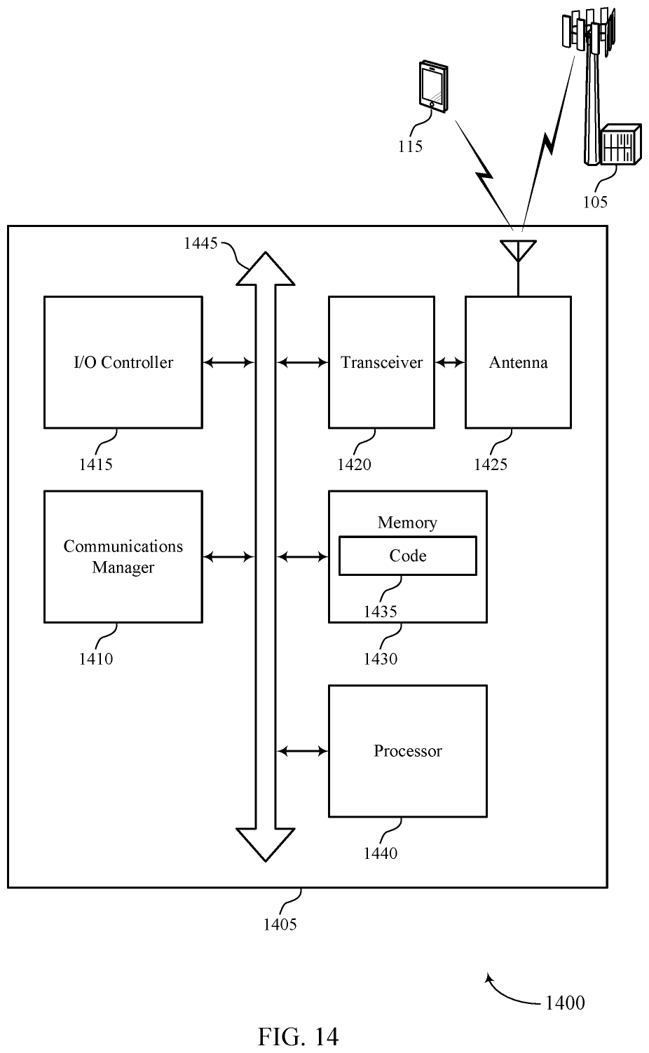

The receiver 1110 may receive information such as packets, user data, or control information associated with various information channels (e.g., control channels, data channels, and information related to S-SSB transmissions in a shared spectrum, etc.). Information may be passed on to other components of the device 1105. The receiver 1110 may be or include aspects of the transceiver 1420 described with reference to FIG. 14. The receiver 1110 may utilize a single antenna or a set of antennas.

The communications manager 1115 may identify a configuration including a first quantity of sidelink synchronization signal block instances for each of a set of sidelink synchronization signal block periods. The communications manager 1115 may determine a second quantity of sidelink synchronization signal block instances for a first sidelink synchronization signal block period of the set of sidelink synchronization signal block periods, where the second quantity is different from the first quantity. The communications manager 1115 may transmit the second quantity of sidelink synchronization signal block instances over the first sidelink synchronization signal block period.

The communications manager 1115 may also transmit a sidelink synchronization signal block burst using one or more beams in a sidelink synchronization signal block period. The communications manager 1115 may identify a configuration for a set of resources of a sidelink beam selection resource pool based on transmitting the sidelink synchronization signal block burst, and receive, from another UE over a resource of the set of resources, a control message including an indication of one or more preferred beams of the one or more beams for transmitting sidelink data to the other UE. The communications manager 1115 may transmit the sidelink data to the other UE using the one or more preferred beams.

The communications manager 1115 may also identify a sidelink synchronization signal block burst transmitted using one or more beams in a sidelink synchronization signal block period. The communications manager 1115 may receive, from another UE, one or more sidelink synchronization signal blocks using the one or more beams. The communications manager 1115 may select one or more preferred beams of the one or more beams based on receiving the one or more sidelink synchronization signal blocks. The communications manager 1115 may transmit a control message including an indication of the one or more preferred beams to the other UE, over a resource of a set of resources of a sidelink beam selection resource pool, where the set of resources of the sidelink beam selection resource pool is associated with the sidelink synchronization signal block burst. The communications manager 1115 may receive sidelink data from the other UE using the one or more preferred beams. The communications manager 1115 may be or include aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some aspects, the communications manager 1115, or its sub-components, may be a separate and distinct component in accordance with various aspects of the present disclosure. In some aspects, the communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some aspects, the transmitter 1120 may be collocated with a receiver 1110 in a transceiver module. In an aspect, the transmitter 1120 may be or include aspects of the transceiver 1420 described with reference to FIG. 14. The transmitter 1120 may utilize a single antenna or a set of antennas.

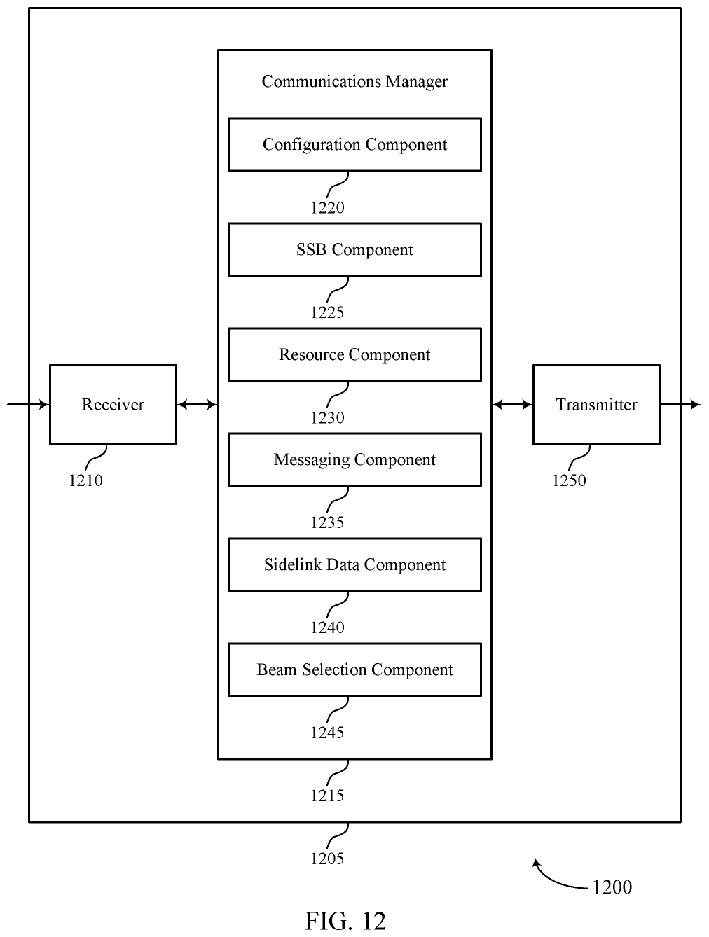

FIG. 12 shows a block diagram 1200 of a device 1205 that supports S-SSB transmissions in a shared spectrum in accordance with aspects of the present disclosure. The device 1205 may be or include aspects of a device 1105, or a UE 115 as described herein. The device 1205 may include a receiver 1210, a communications manager 1215, and a transmitter 1250. The device 1205 may also include a processor. Each of these components may be in communication with one another (e.g., via one or more buses).

The receiver 1210 may receive information such as packets, user data, or control information associated with various information channels (e.g., control channels, data channels, and information related to S-SSB transmissions in a shared spectrum, etc.). Information may be passed on to other components of the device 1205. The receiver 1210 may be or include aspects of the transceiver 1420 described with reference to FIG. 14. The receiver 1210 may utilize a single antenna or a set of antennas.

The communications manager 1215 may be or include aspects of the communications manager 1115 as described herein. The communications manager 1215 may include a configuration component 1220, a SSB component 1225, a resource component 1230, a messaging component 1235, a sidelink data component 1240, and a beam selection component 1245. The communications manager 1215 may be or include aspects of the communications manager 1410 described herein.

The configuration component 1220 may identify a configuration including a first quantity of S-SSB instances for each of a set of S-SSB periods.

The SSB component 1225 may determine a second quantity of S-SSB instances for a first S-SSB period of the set of S-SSB periods, where the second quantity is different from the first quantity and transmit the second quantity of S-SSB instances over the first S-SSB period.

The SSB component 1225 may transmit a S-SSB burst using one or more beams in a S-SSB period.

The resource component 1230 may identify a configuration for a set of resources of a sidelink beam selection resource pool based on transmitting the S-SSB burst.

The messaging component 1235 may receive, from another UE over a resource of the set of resources, a control message including an indication of one or more preferred beams of the one or more beams for transmitting sidelink data to the other UE.

The sidelink data component 1240 may transmit the sidelink data to the other UE using the one or more preferred beams.

The SSB component 1225 may identify a S-SSB burst transmitted using one or more beams in a S-SSB period and receive, from another UE, one or more S-SSBs using the one or more beams.

The beam selection component 1245 may select one or more preferred beams of the one or more beams based on receiving the one or more S-SSBs.

The messaging component 1235 may transmit a control message including an indication of the one or more preferred beams to the other UE, over a resource of a set of resources of a sidelink beam selection resource pool, where the set of resources of the sidelink beam selection resource pool is associated with the S-SSB burst.

The sidelink data component 1240 may receive sidelink data from the other UE using the one or more preferred beams.

The transmitter 1250 may transmit signals generated by other components of the device 1205. In some aspects, the transmitter 1250 may be collocated with a receiver 1210 in a transceiver module. In an aspect, the transmitter 1250 may be or include aspects of the transceiver 1420 described with reference to FIG. 14. The transmitter 1250 may utilize a single antenna or a set of antennas.

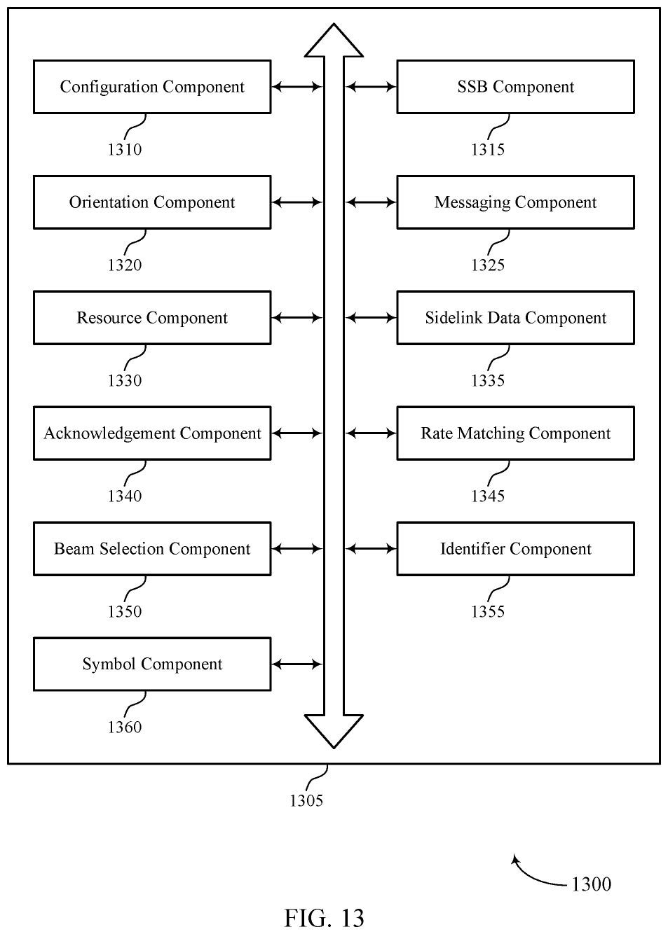

FIG. 13 shows a block diagram 1300 of a communications manager 1305 that supports S-SSB transmissions in a shared spectrum in accordance with aspects of the present disclosure. The communications manager 1305 may be or include aspects of a communications manager 1115, a communications manager 1215, or a communications manager 1410 described herein. The communications manager 1305 may include a configuration component 1310, a SSB component 1315, an orientation component 1320, a messaging component 1325, a resource component 1330, a sidelink data component 1335, an acknowledgement component 1340, a rate matching component 1345, a beam selection component 1350, an identifier component 1355, and a symbol component 1360. Each of these modules may communicate, directly or indirectly, with one another (e.g., via one or more buses).

The configuration component 1310 may identify a configuration including a first quantity of S-SSB instances for each of a set of S-SSB periods. The SSB component 1315 may determine a second quantity of S-SSB instances for a first S-SSB period of the set of S-SSB periods, where the second quantity is different from the first quantity. In some aspects, the SSB component 1315 may transmit the second quantity of S-SSB instances over the first S-SSB period. In some aspects, the SSB component 1315 may transmit a S-SSB burst using one or more beams in a S-SSB period. In some aspects, the SSB component 1315 may identify a S-SSB burst transmitted using one or more beams in a S-SSB period. In some aspects, the SSB component 1315 may receive, from another UE, one or more S-SSBs using the one or more beams.

In some aspects, the SSB component 1315 may determine a subsampling of S-SSBs associated with the first quantity of S-SSB instances. In some aspects, the SSB component 1315 may determine the second quantity of S-SSB instances based on determining the orientational movement. In some aspects, the SSB component 1315 may transmit the first quantity of S-SSB instances over a third S-SSB period based on determining that the orientational movement of the UE over the second S-SSB period satisfies the orientational movement threshold.

The messaging component 1325 may receive, from another UE over a resource of the set of resources, a control message including an indication of one or more preferred beams of the one or more beams for transmitting sidelink data to the other UE. In some aspects, the messaging component 1325 may transmit a control message including an indication of the one or more preferred beams to the other UE, over a resource of a set of resources of a sidelink beam selection resource pool, where the set of resources of the sidelink beam selection resource pool is associated with the S-SSB burst. In some aspects, the messaging component 1325 may receive a message from a base station, where identifying the configuration for the first quantity of S-SSB instances is based on receiving the message. In some aspects, the messaging component 1325 may receive a first control message in a physical sidelink control channel transmission.

In some aspects, the messaging component 1325 may receive a second control message in a physical sidelink shared channel transmission, where the second control message includes the indication. In some aspects, the messaging component 1325 may identify the priority associated with the second control message based on the first control message. In some aspects, the messaging component 1325 may receive the second control message based on identifying the priority. In some aspects, receiving the control message includes receiving a medium access control (MAC) control element (MAC-CE) including the indication of the one or more preferred beams.

In some aspects, the messaging component 1325 may transmit a first control message in a physical sidelink control channel transmission. In some aspects, the messaging component 1325 may transmit a second control message in a physical sidelink shared channel transmission, where the second control message includes the indication. In some aspects, the messaging component 1325 may identify that the second control message includes fewer information bits than a quantity of bits available in resources of a slot of a physical sidelink shared channel.

In some aspects, the messaging component 1325 may set the priority associated with the second control message. In some aspects, the messaging component 1325 may indicate, in the first control message, the priority associated with the second control message. In some aspects, the messaging component 1325 may transmit the second control message based on setting the priority, transmitting the first control message indicating the priority, or both. In some aspects, the messaging component 1325 may transmit a MAC-CE, where the MAC-CE includes the indication.

In some cases, the indication may include a beam index associated with the one or more preferred beams. In some cases, the indication may include a reference signal received power value associated with the one or more preferred beams. In some cases, the indication may include a source identifier associated with the UE (or the other UE). In some cases, the indication may include a destination identifier associated with the other UE (or the UE). In some cases, the indication may include a trigger associated with transmitting an acknowledgement indicator corresponding to the one or more preferred beams. In some cases, the indication may include a new data indicator. In some cases, the indication may include a hybrid automatic repeat request identifier.

The resource component 1330 may identify a configuration for a set of resources of a sidelink beam selection resource pool based on transmitting the S-SSB burst. In some aspects, the resource component 1330 may identify, based on a field of the first control message, that the physical sidelink shared channel transmission is within a first subset of resources of a slot of the physical sidelink shared channel. In some aspects, the resource component 1330 may identify that a second subset of resources of the slot of the physical sidelink shared channel includes rate matching information associated with the second control message. In some aspects, the resource component 1330 may receive the second control message based on the rate matching information. In some aspects, the resource component 1330 may suppress transmission of the physical sidelink shared channel transmission for a second subset of resources of the slot of the physical sidelink shared channel.

In some aspects, the resource component 1330 may identify, based on the second control message, a last symbol of the first subset of resources of the slot. In some aspects, the resource component 1330 may indicate, in a field of the first control message, that the physical sidelink shared channel transmission is within a first subset of resources of the slot of the physical sidelink shared channel. In some aspects, the resource component 1330 may identify that a second subset of resources of the slot of the physical sidelink shared channel is exclusive of the physical sidelink shared channel transmission. In some aspects, the resource component 1330 may map the second control message to the first subset of resources of the physical sidelink shared channel based on identifying the first symbol.

In some aspects, the resource component 1330 may determine a set of sets of resources based on a number of beams associated with the S-SSB burst, where the physical sidelink feedback channel includes the set of sets of resources. In some aspects, the resource component 1330 may select one or more sets of resources from the set of sets of resources based on the one or more preferred beams. In some aspects, the resource component 1330 may select one or more resources of the one or more sets of resources based on.

In some cases, the sidelink beam selection resource pool may include resources of a physical feedback sidelink channel. In some cases, the physical feedback sidelink channel may include a set of sets of resources determined based on a number of beams associated with the S-SSB burst. In some cases, the sidelink beam selection resource pool may include resources or a physical feedback sidelink channel.

The sidelink data component 1335 may transmit the sidelink data to the other UE using the one or more preferred beams. In some aspects, the sidelink data component 1335 may receive sidelink data from the other UE using the one or more preferred beams. In some aspects, transmitting the sidelink data to the other UE using the one or more preferred beams may include transmitting the sidelink data to the other UE using the selected beam. In some aspects, receiving the sidelink data from the other UE using the one or more preferred beams may include receiving the sidelink data from the other UE using the selected beam.

The beam selection component 1350 may select one or more preferred beams of the one or more beams based on receiving the one or more S-SSBs. In some aspects, the beam selection component 1350 may select a beam from the one or more preferred beams. In some aspects, the beam selection component 1350 may determine the one or more preferred beams based on an association between the set of physical sidelink feedback channel resources and the one or more beams. In some aspects, the beam selection component 1350 may transmit the indication of the one or more preferred beams to the other UE over the selected one or more resources.

The orientation component 1320 may determine an orientational movement of the UE over one or more S-SSB periods based on an orientation sensor of the UE. In some aspects, the orientation component 1320 may determine that an orientational movement of the UE over a second S-SSB period satisfies an orientational movement threshold.

The acknowledgement component 1340 may transmit an acknowledgement associated with the one or more preferred beams, using at least a portion of the second subset of resources of the slot. In some aspects, the acknowledgement component 1340 may transmit an acknowledgement indicator to the other UE on a physical sidelink feedback channel resource using the one or more preferred beams. In some aspects, the acknowledgement component 1340 may transmit an acknowledgement indicator to the other UE on a physical sidelink feedback channel resource associated with the selected beam.

In some aspects, the acknowledgement component 1340 may receive a positive acknowledgement indicator from the other UE over a set of physical sidelink feedback channel resources included in the set of resources for the sidelink beam selection resource pool. In some aspects, the acknowledgement component 1340 may receive an acknowledgement associated with the one or more preferred beams, using at least a portion of the second subset of resources of the slot. In some aspects, the acknowledgement component 1340 may receive an acknowledgement indicator from the other UE on a physical sidelink feedback channel resource using the one or more preferred beams. In some aspects, the acknowledgement component 1340 may receive an acknowledgement indicator from the other UE on a physical sidelink feedback channel resource associated with a beam selected from the one or more preferred beams by the other UE.

The rate matching component 1345 may identify rate matching information associated with the second control message in at least one resource associated with the last symbol. In some aspects, the rate matching component 1345 may transmit rate matching information associated with the second control message over a second subset of resources of the slot of the physical sidelink shared channel. In some aspects, the rate matching component 1345 may transmit rate matching information associated with the second control message in at least one resource associated with the last symbol.

The identifier component 1355 may determine a UE identifier associated with the other UE based on a resource included in the set of physical sidelink feedback channel resources. The symbol component 1360 may identify, from a set of symbols associated with the physical sidelink shared channel, a first symbol carrying a demodulation reference signal.

In some aspects, the symbol component 1360 may identify a last symbol of the first subset of resources of the slot.

FIG. 14 shows a diagram of a system 1400 including a device 1405 that supports S-SSB transmissions in a shared spectrum in accordance with aspects of the present disclosure. The device 1405 may be an example of or include the components of device 1105, device 1205, or a UE 115 as described herein. The device 1405 may include components for bi-directional voice and data communications including components for transmitting and receiving communications, including a communications manager 1410, an I/O controller 1415, a transceiver 1420, an antenna 1425, memory 1430, and a processor 1440. These components may be electronically coupled via one or more buses (e.g., bus 1445).

The communications manager 1410 may identify a configuration including a first quantity of S-SSB instances for each of a set of S-SSB periods, determine a second quantity of S-SSB instances for a first S-SSB period of the set of S-SSB periods, where the second quantity is different from the first quantity, and transmit the second quantity of S-SSB instances over the first S-SSB period.

The communications manager 1410 may also transmit a S-SSB burst using one or more beams in a S-SSB period, identify a configuration for a set of resources of a sidelink beam selection resource pool based on transmitting the S-SSB burst, receive, from another UE over a resource of the set of resources, a control message including an indication of one or more preferred beams of the one or more beams for transmitting sidelink data to the other UE, and transmit the sidelink data to the other UE using the one or more preferred beams.

The communications manager 1410 may also identify a S-SSB burst transmitted using one or more beams in a S-SSB period, receive, from another UE, one or more S-SSBs using the one or more beams, select one or more preferred beams of the one or more beams based on receiving the one or more S-SSBs, transmit a control message including an indication of the one or more preferred beams to the other UE, over a resource of a set of resources of a sidelink beam selection resource pool, where the set of resources of the sidelink beam selection resource pool is associated with the S-SSB burst, and receive sidelink data from the other UE using the one or more preferred beams.

The I/O controller 1415 may manage input and output signals for the device 1405. The I/O controller 1415 may also manage peripherals not integrated into the device 1405. In some cases, the I/O controller 1415 may represent a physical connection or port to an external peripheral. In some cases, the I/O controller 1415 may utilize an operating system such as iOS®, ANDROID®, MS-DOS®, MS-WINDOWS®, OS/2®, UNIX®, LINUX®, or another known operating system. In other cases, the I/O controller 1415 may represent or interact with a modem, a keyboard, a mouse, a touchscreen, or a similar device. In some cases, the I/O controller 1415 may be implemented as part of a processor. In some cases, a user may interact with the device 1405 via the I/O controller 1415 or via hardware components controlled by the I/O controller 1415.

The transceiver 1420 may communicate bi-directionally, via one or more antennas, wired, or wireless links as described above. In an aspect, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include random-access memory (RAM) and read-only memory (ROM). The memory 1430 may store computer-readable, computer-executable code 1435 including instructions that, when executed, cause the processor to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting S-SSB transmissions in a shared spectrum).

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

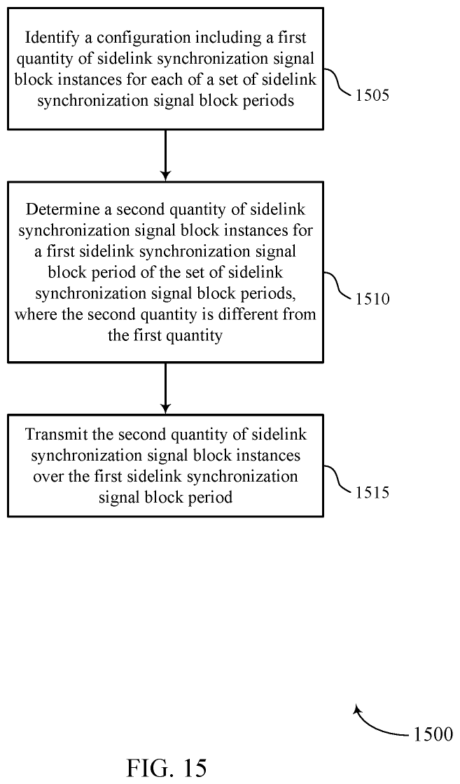

FIG. 15 shows a flowchart illustrating a method 1500 that supports S-SSB (S-SSB) transmissions in a shared spectrum in accordance with aspects of the present disclosure. The operations of method 1500 may be implemented by a UE 115 or its components as described herein. In an aspect, the operations of method 1500 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 1505, the UE may identify a configuration including a first quantity of S-SSB instances for each of a set of S-SSB periods. The operations of 1505 may be performed according to the methods described herein. Aspects of the operations of 1505 may be performed by a configuration component as described with reference to FIGS. 11 through 14.

At 1510, the UE may determine a second quantity of S-SSB instances for a first S-SSB period of the set of S-SSB periods, where the second quantity is different from the first quantity. In some aspects, the UE may determine a subsampling of S-SSBs associated with the first quantity of S-SSB instances. The operations of 1510 may be performed according to the methods described herein. Aspects of the operations of 1510 may be performed by a SSB component as described with reference to FIGS. 11 through 14.

At 1515, the UE may transmit the second quantity of S-SSB instances over the first S-SSB period. The operations of 1515 may be performed according to the methods described herein. Aspects of the operations of 1515 may be performed by a SSB component as described with reference to FIGS. 11 through 14.

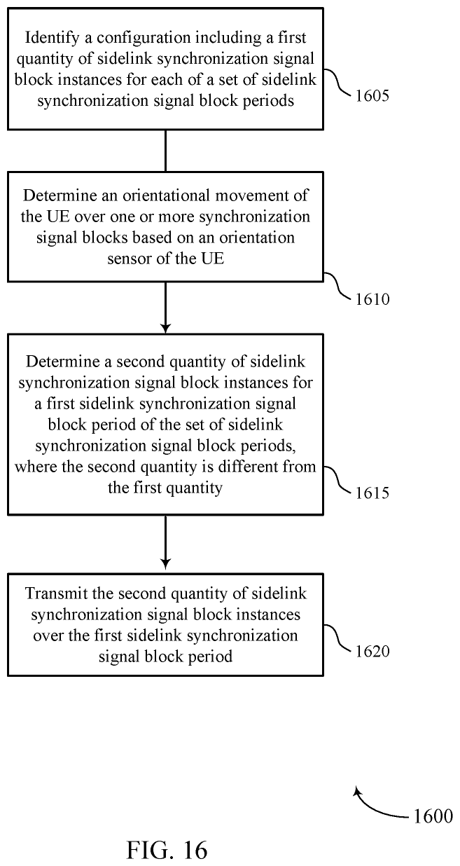

FIG. 16 shows a flowchart illustrating a method 1600 that supports S-SSB transmissions in a shared spectrum in accordance with aspects of the present disclosure. The operations of method 1600 may be implemented by a UE 115 or its components as described herein. In an aspect, the operations of method 1600 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 1605, the UE may identify a configuration including a first quantity of S-SSB instances for each of a set of S-SSB periods. The operations of 1605 may be performed according to the methods described herein. Aspects of the operations of 1605 may be performed by a configuration component as described with reference to FIGS. 11 through 14.

At 1610, the UE may determine an orientational movement of the UE over one or more S-SSB periods based on an orientation sensor of the UE. The operations of 1610 may be performed according to the methods described herein. Aspects of the operations of 1610 may be performed by a SSB component as described with reference to FIGS. 11 through 14.

At 1615, the UE may determine a second quantity of S-SSB instances for a first S-SSB period of the set of S-SSB periods, where the second quantity is different from the first quantity. In some aspects, the UE may determine a second quantity of S-SSB instances based on determining the orientational movement. The operations of 1615 may be performed according to the methods described herein. Aspects of the operations of 1615 may be performed by a SSB component as described with reference to FIGS. 11 through 14.

At 1620, the UE may transmit the second quantity of S-SSB instances over the first S-SSB period. The operations of 1620 may be performed according to the methods described herein. Aspects of the operations of 1620 may be performed by a SSB component as described with reference to FIGS. 11 through 14.

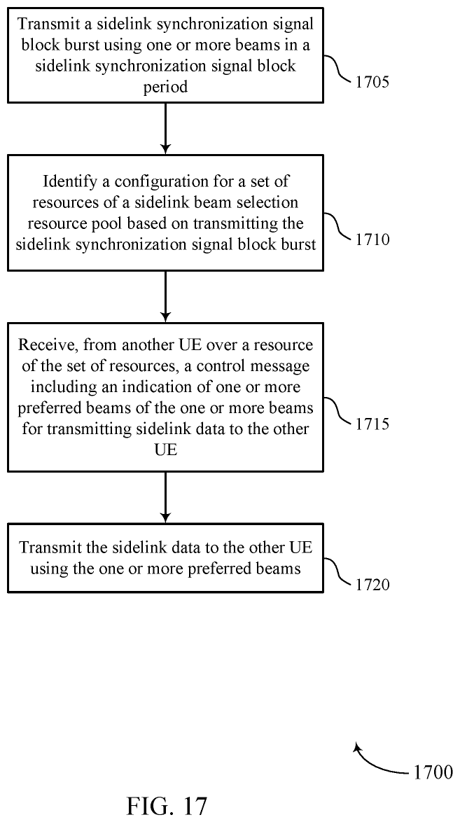

FIG. 17 shows a flowchart illustrating a method 1700 that supports S-SSB (S-SSB) transmissions in a shared spectrum in accordance with aspects of the present disclosure. The operations of method 1700 may be implemented by a UE 115 or its components as described herein. In an aspect, the operations of method 1700 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 1705, the UE may transmit a S-SSB burst using one or more beams in a S-SSB period. The operations of 1705 may be performed according to the methods described herein. Aspects of the operations of 1705 may be performed by a SSB component as described with reference to FIGS. 11 through 14.

At 1710, the UE may identify a configuration for a set of resources of a sidelink beam selection resource pool based on transmitting the S-SSB burst. The operations of 1710 may be performed according to the methods described herein. Aspects of the operations of 1710 may be performed by a resource component as described with reference to FIGS. 11 through 14.

At 1715, the UE may receive, from another UE over a resource of the set of resources, a control message including an indication of one or more preferred beams of the one or more beams for transmitting sidelink data to the other UE. The operations of 1715 may be performed according to the methods described herein. Aspects of the operations of 1715 may be performed by a messaging component as described with reference to FIGS. 11 through 14.

At 1720, the UE may transmit the sidelink data to the other UE using the one or more preferred beams. The operations of 1720 may be performed according to the methods described herein. Aspects of the operations of 1720 may be performed by a sidelink data component as described with reference to FIGS. 11 through 14.

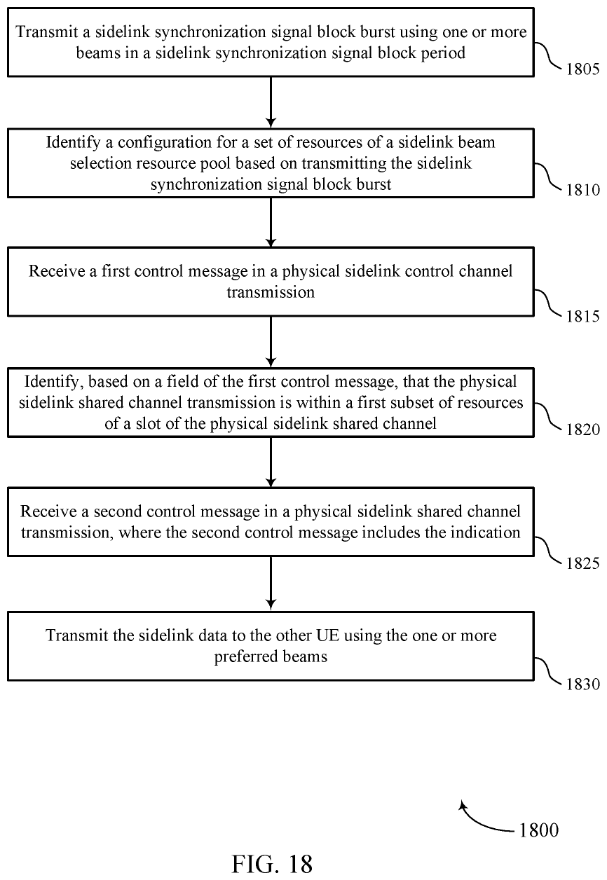

FIG. 18 shows a flowchart illustrating a method 1800 that supports S-SSB transmissions in a shared spectrum in accordance with aspects of the present disclosure. The operations of method 1800 may be implemented by a UE 115 or its components as described herein. In an aspect, the operations of method 1800 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 1805, the UE may transmit a S-SSB burst using one or more beams in a S-SSB period. The operations of 1805 may be performed according to the methods described herein. Aspects of the operations of 1805 may be performed by a SSB component as described with reference to FIGS. 11 through 14.

At 1810, the UE may identify a configuration for a set of resources of a sidelink beam selection resource pool based on transmitting the S-SSB burst. The operations of 1810 may be performed according to the methods described herein. Aspects of the operations of 1810 may be performed by a resource component as described with reference to FIGS. 11 through 14.

At 1815, the UE may receive a first control message in a physical sidelink control channel transmission. The operations of 1815 may be performed according to the methods described herein. Aspects of the operations of 1815 may be performed by a messaging component as described with reference to FIGS. 11 through 14.

At 1820, the UE may identify, based on a field of the first control message, that the physical sidelink shared channel transmission is within a first subset of resources of a slot of the physical sidelink shared channel. The operations of 1820 may be performed according to the methods described herein. Aspects of the operations of 1820 may be performed by a messaging component as described with reference to FIGS. 11 through 14.

The UE may receive, from another UE over a resource of the set of resources, a control message including an indication of one or more preferred beams of the one or more beams for transmitting sidelink data to the other UE. In an aspect, at 1825, the UE may receive a second control message in a physical sidelink shared channel transmission, where the second control message includes the indication. The operations of 1825 may be performed according to the methods described herein. Aspects of the operations of 1825 may be performed by a resource component as described with reference to FIGS. 11 through 14.

At 1830, the UE may transmit the sidelink data to the other UE using the one or more preferred beams. The operations of 1830 may be performed according to the methods described herein. Aspects of the operations of 1830 may be performed by a messaging component as described with reference to FIGS. 11 through 14.

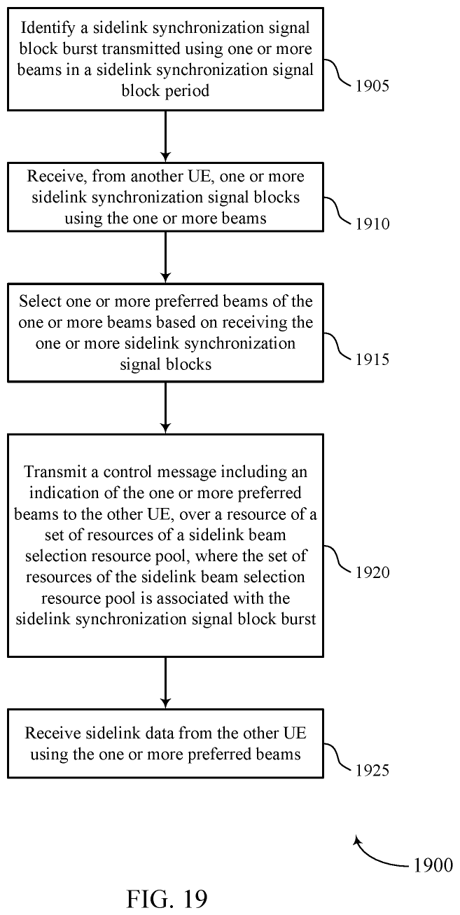

FIG. 19 shows a flowchart illustrating a method 1900 that supports S-SSB transmissions in a shared spectrum in accordance with aspects of the present disclosure. The operations of method 1900 may be implemented by a UE 115 or its components as described herein. In an aspect, the operations of method 1900 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 1905, the UE may identify a S-SSB burst transmitted using one or more beams in a S-SSB period. The operations of 1905 may be performed according to the methods described herein. Aspects of the operations of 1905 may be performed by a SSB component as described with reference to FIGS. 11 through 14.

At 1910, the UE may receive, from another UE, one or more S-SSBs using the one or more beams. The operations of 1910 may be performed according to the methods described herein. Aspects of the operations of 1910 may be performed by a SSB component as described with reference to FIGS. 11 through 14.

At 1915, the UE may select one or more preferred beams of the one or more beams based on receiving the one or more S-SSBs. The operations of 1915 may be performed according to the methods described herein. Aspects of the operations of 1915 may be performed by a beam selection component as described with reference to FIGS. 11 through 14.

At 1920, the UE may transmit a control message including an indication of the one or more preferred beams to the other UE, over a resource of a set of resources of a sidelink beam selection resource pool, where the set of resources of the sidelink beam selection resource pool is associated with the S-SSB burst. The operations of 1920 may be performed according to the methods described herein. Aspects of the operations of 1920 may be performed by a messaging component as described with reference to FIGS. 11 through 14.

At 1925, the UE may receive sidelink data from the other UE using the one or more preferred beams. The operations of 1925 may be performed according to the methods described herein. Aspects of the operations of 1925 may be performed by a sidelink data component as described with reference to FIGS. 11 through 14.

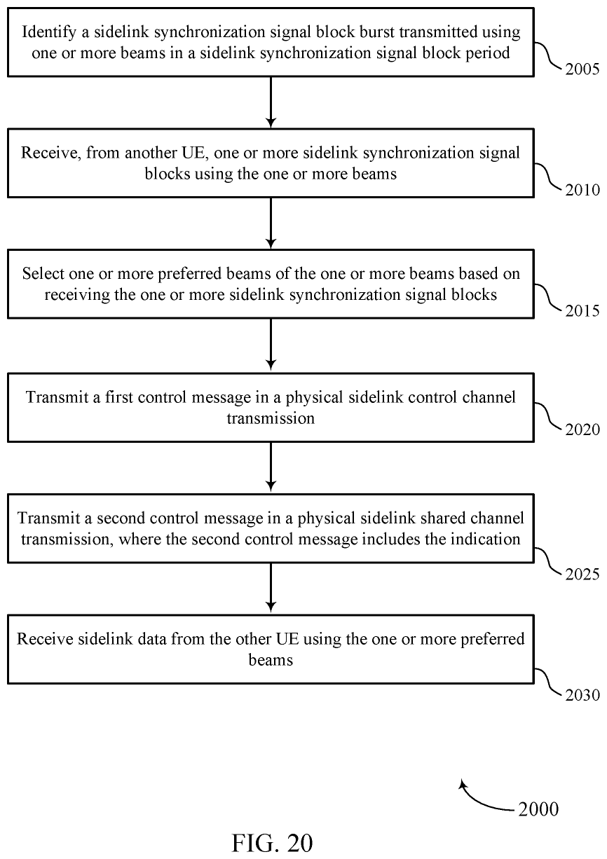

FIG. 20 shows a flowchart illustrating a method 2000 that supports S-SSB transmissions in a shared spectrum in accordance with aspects of the present disclosure. The operations of method 2000 may be implemented by a UE 115 or its components as described herein. In an aspect, the operations of method 2000 may be performed by a communications manager as described with reference to FIGS. 11 through 14. In some aspects, a UE may execute a set of instructions to control the functional elements of the UE to perform the functions described below. Additionally or alternatively, a UE may perform aspects of the functions described below using special-purpose hardware.

At 2005, the UE may identify a S-SSB burst transmitted using one or more beams in a S-SSB period. The operations of 2005 may be performed according to the methods described herein. Aspects of the operations of 2005 may be performed by a SSB component as described with reference to FIGS. 11 through 14.

At 2010, the UE may receive, from another UE, one or more S-SSBs using the one or more beams. The operations of 2010 may be performed according to the methods described herein. Aspects of the operations of 2010 may be performed by a SSB component as described with reference to FIGS. 11 through 14.

At 2015, the UE may select one or more preferred beams of the one or more beams based on receiving the one or more S-SSBs. The operations of 2015 may be performed according to the methods described herein. Aspects of the operations of 2015 may be performed by a beam selection component as described with reference to FIGS. 11 through 14.

At 2020, the UE may transmit a first control message in a physical sidelink control channel transmission. The operations of 2020 may be performed according to the methods described herein. Aspects of the operations of 2020 may be performed by a messaging component as described with reference to FIGS. 11 through 14.

The UE may transmit a control message including an indication of the one or more preferred beams to the other UE, over a resource of a set of resources of a sidelink beam selection resource pool, where the set of resources of the sidelink beam selection resource pool is associated with the S-SSB burst. In an aspect, at 2025, the UE may transmit a second control message in a physical sidelink shared channel transmission, where the second control message includes the indication. The operations of 2025 may be performed according to the methods described herein. Aspects of the operations of 2025 may be performed by a messaging component as described with reference to FIGS. 11 through 14.

At 2030, the UE may receive sidelink data from the other UE using the one or more preferred beams. The operations of 2030 may be performed according to the methods described herein. Aspects of the operations of 2030 may be performed by a resource component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. In an aspect, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. In an aspect, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. In an aspect, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. In an aspect, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, In an aspect, a list of at least one of A, B, or C means A or B or C or AB or AC or BC or ABC (i.e., A and B and C). Also, as used herein, the phrase “based on” shall not be construed as a reference to a closed set of conditions. In an aspect, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1-5. (canceled)

6. A method for wireless communication implemented by a user equipment (UE), comprising:
transmitting a sidelink synchronization signal block burst using one or more beams in a sidelink synchronization signal block period;
identifying a configuration for a set of resources of a sidelink beam selection resource pool based at least in part on transmitting the sidelink synchronization signal block burst;
receiving, from another UE over a resource of the set of resources, a control message comprising an indication of one or more preferred beams of the one or more beams for transmitting sidelink data to the other UE; and
transmitting the sidelink data to the other UE using the one or more preferred beams.

7. The method of claim 6, wherein the receiving the control message comprises:
receiving a first control message in a physical sidelink control channel transmission; and
receiving a second control message in a physical sidelink shared channel transmission, wherein the second control message comprises the indication.

8. The method of claim 7, further comprising:
identifying, based at least in part on a field of the first control message, that the physical sidelink shared channel transmission is within a first subset of resources of a slot of the physical sidelink shared channel.

9-19. (canceled)

20. A method for wireless communication implemented by a user equipment (UE), comprising:
identifying a sidelink synchronization signal block burst transmitted using one or more beams in a sidelink synchronization signal block period;
receiving, from another UE, one or more sidelink synchronization signal blocks using the one or more beams;
selecting one or more preferred beams of the one or more beams based at least in part on receiving the one or more sidelink synchronization signal blocks;
transmitting a control message comprising an indication of the one or more preferred beams to the other UE, over a resource of a set of resources of a sidelink beam selection resource pool, wherein the set of resources of the sidelink beam selection resource pool is associated with the sidelink synchronization signal block burst; and
receiving sidelink data from the other UE using the one or more preferred beams.

21. The method of claim 20, wherein the transmitting the control message comprises:
transmitting a first control message in a physical sidelink control channel transmission; and
transmitting a second control message in a physical sidelink shared channel transmission, wherein the second control message comprises the indication.

22. The method of claim 21, further comprising:
identifying that the second control message comprises fewer information bits than a quantity of bits available in resources of a slot of a physical sidelink shared channel; and
indicating, in a field of the first control message, that the physical sidelink shared channel transmission is within a first subset of resources of the slot of the physical sidelink shared channel.

23-35. (canceled)

36. An apparatus for wireless communication implemented by a user equipment (UE), comprising:
a processor, and
memory coupled with the processor, wherein the memory comprises instructions executable by the processor to cause the apparatus to:
identify a configuration comprising a first quantity of sidelink synchronization signal block instances for each of a plurality of sidelink synchronization signal block periods;
determine a second quantity of sidelink synchronization signal block instances for a first sidelink synchronization signal block period of the plurality of sidelink synchronization signal block periods, wherein the second quantity is different from the first quantity; and
transmit the second quantity of sidelink synchronization signal block instances over the first sidelink synchronization signal block period.

37-40. (canceled)

41. An apparatus for wireless communication implemented by a user equipment (UE), comprising:
a processor; and
memory coupled with the processor, wherein the memory comprises instructions executable by the processor to cause the apparatus to:
transmit a sidelink synchronization signal block burst using one or more beams in a sidelink synchronization signal block period;
identify a configuration for a set of resources of a sidelink beam selection resource pool based at least in part on transmitting the sidelink synchronization signal block burst;
receive, from another UE over a resource of the set of resources, a control message comprising an indication of one or more preferred beams of the one or more beams for transmitting sidelink data to the other UE; and
transmit the sidelink data to the other UE using the one or more preferred beams.

42. The apparatus of claim 41, wherein the instructions to receive the control message are executable by the processor to cause the apparatus to:
receive a first control message in a physical sidelink control channel transmission; and
receive a second control message in a physical sidelink shared channel transmission, wherein the second control message comprises the indication.

43. The apparatus of claim 42, wherein the instructions are further executable by the processor to cause the apparatus to:
identify, based at least in part on a field of the first control message, that the physical sidelink shared channel transmission is within a first subset of resources of a slot of the physical sidelink shared channel.

44. The apparatus of claim 43, wherein the instructions are further executable by the processor to cause the apparatus to:
identify that a second subset of resources of the slot of the physical sidelink shared channel comprises rate matching information associated with the second control message; and
receive the second control message based at least in part on the rate matching information.

45. The apparatus of claim 43, wherein the instructions are further executable by the processor to cause the apparatus to:
identify that a second subset of resources of the slot of the physical sidelink shared channel is exclusive of the physical sidelink shared channel transmission; and
transmit an acknowledgement associated with the one or more preferred beams, using at least a portion of the second subset of resources of the slot.

46. The apparatus of claim 43, wherein the instructions are further executable by the processor to cause the apparatus to:
identify, based at least in part on the second control message, a last symbol of the first subset of resources of the slot; and
identify rate matching information associated with the second control message in at least one resource associated with the last symbol.

47. The apparatus of claim 42, wherein the second control message comprises:
a beam index associated with the one or more preferred beams;
a reference signal received power value associated with the one or more preferred beams;
a source identifier associated with the UE;
a destination identifier associated with the other UE;
a trigger associated with transmitting an acknowledgement indicator corresponding to the one or more preferred beams;
a new data indicator;
a hybrid automatic repeat request identifier; or
a combination thereof.

48. The apparatus of claim 42, wherein the instructions are further executable by the processor to cause the apparatus to:
transmit an acknowledgement indicator to the other UE on a physical sidelink feedback channel resource using the one or more preferred beams.

49. The apparatus of claim 42, wherein the instructions are further executable by the processor to cause the apparatus to:
select a beam from the one or more preferred beams;
transmit an acknowledgement indicator to the other UE on a physical sidelink feedback channel resource associated with the selected beam,
wherein transmitting the sidelink data to the other UE using the one or more preferred beams comprises transmitting the sidelink data to the other UE using the selected beam.

50. The apparatus of claim 42, wherein the first control message indicates a priority associated with the second control message, and the instructions are further executable by the processor to cause the apparatus to:
identify the priority associated with the second control message based at least in part on the first control message; and
receive the second control message based at least in part on identifying the priority.

51. (canceled)

52. The apparatus of claim 41, wherein a physical feedback sidelink channel comprises a plurality of sets of resources determined based on a number of beams associated with the sidelink synchronization signal block burst, and wherein the sidelink beam selection resource pool comprises resources of the physical feedback sidelink channel.

53. The apparatus of claim 41, wherein the instructions are further executable by the processor to cause the apparatus to:
receive a positive acknowledgement indicator from the other UE over a set of physical sidelink feedback channel resources included in the set of resources for the sidelink beam selection resource pool;
determine the one or more preferred beams based at least in part on an association between the set of physical sidelink feedback channel resources and the one or more beams; and
determine a UE identifier associated with the other UE based at least in part on a resource included in the set of physical sidelink feedback channel resources.

54. The apparatus of claim 41, wherein the instructions to receive the control message are executable by the processor to cause the apparatus to receive a medium access control (MAC) control element (MAC-CE) comprising the indication of the one or more preferred beams.

55. An apparatus for wireless communication implemented by a user equipment (UE), comprising:
a processor; and
memory coupled with the processor, wherein the memory comprises instructions executable by the processor to cause the apparatus to:
identify a sidelink synchronization signal block burst transmitted using one or more beams in a sidelink synchronization signal block period;
receive, from another UE, one or more sidelink synchronization signal blocks using the one or more beams;
select one or more preferred beams of the one or more beams based at least in part on receiving the one or more sidelink synchronization signal blocks;
transmit a control message comprising an indication of the one or more preferred beams to the other UE, over a resource of a set of resources of a sidelink beam selection resource pool, wherein the set of resources of the sidelink beam selection resource pool is associated with the sidelink synchronization signal block burst; and
receive sidelink data from the other UE using the one or more preferred beams.

56. The apparatus of claim 55, wherein the instructions to transmit the control message are executable by the processor to cause the apparatus to:
transmit a first control message in a physical sidelink control channel transmission; and
transmit a second control message in a physical sidelink shared channel transmission, wherein the second control message comprises the indication.

57. The apparatus of claim 56, wherein the instructions are further executable by the processor to cause the apparatus to:
identify that the second control message comprises fewer information bits than a quantity of bits available in resources of a slot of a physical sidelink shared channel;
identify that the second control message comprises no information bits to be transmitted over a second subset of resources of the slot of the physical sidelink shared channel; and
indicate, in a field of the first control message, that the physical sidelink shared channel transmission is within a first subset of resources of the slot of the physical sidelink shared channel.

58. The apparatus of claim 57, wherein the instructions are further executable by the processor to cause the apparatus to:
transmit rate matching information associated with the second control message over the second subset of resources of the slot of the physical sidelink shared channel.

59. The apparatus of claim 57, wherein the instructions are further executable by the processor to cause the apparatus to:
suppress transmission of the physical sidelink shared channel transmission for a second subset of resources of the slot of the physical sidelink shared channel.

60. The apparatus of claim 57, wherein the instructions are further executable by the processor to cause the apparatus to:
receive an acknowledgement associated with the one or more preferred beams, using at least a portion of the second subset of resources of the slot.

61. The apparatus of claim 57, wherein the instructions are further executable by the processor to cause the apparatus to:
identify, from a set of symbols associated with the physical sidelink shared channel, a first symbol carrying a demodulation reference signal; and
map the second control message to the first subset of resources of the physical sidelink shared channel based at least in part on identifying the first symbol.

62. The apparatus of claim 57, wherein the instructions are further executable by the processor to cause the apparatus to:
identify a last symbol of the first subset of resources of the slot; and
transmit rate matching information associated with the second control message in at least one resource associated with the last symbol.

63. The apparatus of claim 56, wherein the second control message comprises:
a beam index associated with the one or more preferred beams;
a reference signal received power value associated with the one or more preferred beams;
a source identifier associated with the other UE;
a destination identifier associated with the UE;
a trigger associated with transmitting an acknowledgement indicator corresponding to the one or more preferred beams;
a new data indicator;
a hybrid automatic repeat request identifier; or
a combination thereof.

64. The apparatus of claim 56, wherein the instructions are further executable by the processor to cause the apparatus to:
receive an acknowledgement indicator from the other UE on a physical sidelink feedback channel resource using the one or more preferred beams.

65. The apparatus of claim 56, wherein the instructions are further executable by the processor to cause the apparatus to:
receive an acknowledgement indicator from the other UE on a physical sidelink feedback channel resource associated with a beam selected from the one or more preferred beams by the other UE,
wherein receiving the sidelink data from the other UE using the one or more preferred beams comprises receiving the sidelink data from the other UE using the selected beam.

66. The apparatus of claim 56, wherein the first control message indicates a priority associated with the second control message, and the instructions are further executable by the processor to cause the apparatus to:
set the priority associated with the second control message;
indicate, in the first control message, the priority associated with the second control message; and
transmit the second control message based at least in part on setting the priority, transmitting the first control message indicating the priority, or both.

67. (canceled)

68. The apparatus of claim 55, wherein the instructions are further executable by the processor to cause the apparatus to:
determine a plurality of sets of resources based on a number of beams associated with the sidelink synchronization signal block burst, wherein a physical sidelink feedback channel comprises the plurality of sets of resources, and wherein the sidelink beam selection resource pool comprises resources of the physical feedback sidelink channel.

69. The apparatus of claim 68, wherein the instructions are further executable by the processor to cause the apparatus to:
select one or more sets of resources from the plurality of sets of resources based on the one or more preferred beams;
select one or more resources of the one or more sets of resources based at least in part on; and
transmit the indication of the one or more preferred beams to the other UE over the selected one or more resources.

70. The apparatus of claim 55, wherein the instructions to transmit the control message are executable by the processor to cause the apparatus to:
transmit a medium access control (MAC) control element (MAC-CE), wherein the MAC-CE comprises the indication.

71-76. (canceled)
